(19) United States
(12) Patent Application Publication
(10) Pub. No.: US 2026/0340139 A1
(43) Pub. Date: Oct. 29, 2026

(54) INTEGRATED PERFORMANCE AND SECURITY TESTING

(71) Applicant: Capital One Services, LLC, McLean, VA (US)

(72) Inventors: Tarun GUPTA, Bear, DE (US); Rajan Jebakumar SAMUEL, Midlothian, VA (US); David LAVEZZO, Pleasant Hill, CA (US); Leowell Ardley BACUDIO, Raleigh, NC (US)

(21) Appl. No.: 19/187,160

(22) Filed: Apr. 23, 2025

(51) Int. Cl. G06F 21/57; G06F 11/3668

(52) U.S. Cl. CPC G06F 21/577; G06F 11/3688; G06F 2221/034

(57) ABSTRACT

In some implementations, a user device may transmit, to an orchestration system and using a first user interface (UI), a configuration for a performance test to execute within one or more cloud computing instances. The user device may receive, from the orchestration system, instructions for a second UI indicating results from the performance test. The user device may transmit, to the orchestration system and using a third UI, a configuration for a security test to execute on one or more applications. The user device may receive, from the orchestration system, instructions for a fourth UI indicating results from the security test. The user device may transmit, to the orchestration system and using a fifth UI, a configuration for an exfiltration test to execute on one or more data stores. The user device may receive, from the orchestration system, instructions for a sixth UI indicating results from the exfiltration test.

### BACKGROUND

In a computerized system, cloud instances, applications, and data stores may be deployed. Additionally, the computerized system may interact with workstations (e.g., laptops or tablets, among other examples) authorized to interact with the cloud instances, the applications, and the data stores.

### SUMMARY

Some implementations described herein relate to a system for providing unified control for testing within a computerized environment. The system may include one or more memories and one or more processors communicatively coupled to the one or more memories. The one or more processors may be configured to output, in response to first input from a user device, instructions for a first user interface (UI). The one or more processors may be configured to receive, from the user device and using the first UI, a configuration for a performance test to execute within one or more cloud computing instances of the computerized environment. The one or more processors may be configured to transmit, using a first application programming interface (API) gateway, instructions to execute the performance test. The one or more processors may be configured to receive, using the first API gateway, results from the performance test. The one or more processors may be configured to output, to the user device, instructions for a second UI that indicates the results from the performance test. The one or more processors may be configured to output, in response to second input from the user device, instructions for a third UI. The one or more processors may be configured to receive, from the user device and using the third UI, a configuration for a security test to execute on one or more applications of the computerized environment. The one or more processors may be configured to transmit, using a second API gateway, instructions to execute the security test. The one or more processors may be configured to receive, using the second API gateway, results from the security test. The one or more processors may be configured to output, to the user device, instructions for a fourth UI that indicates the results from the security test. The one or more processors may be configured to output, in response to third input from the user device, instructions for a fifth UI. The one or more processors may be configured to receive, from the user device and using the fifth UI, a configuration for a data exfiltration test to execute on one or more data stores of the computerized environment. The one or more processors may be configured to transmit, using a service layer, instructions to execute the data exfiltration test. The one or more processors may be configured to receive, using the service layer, results from the data exfiltration test. The one or more processors may be configured to output, to the user device, instructions for a sixth UI that indicates the results from the data exfiltration test.

Some implementations described herein relate to a method of using unified control of testing within a computerized environment. The method may include transmitting, to an orchestration system and from a user device, first input. The method may include receiving, from the orchestration system and at the user device, instructions for a first UI in response to the first input. The method may include transmitting, to the orchestration system, from the user device, and using the first UI, a configuration for a performance test to execute within one or more cloud computing instances of the computerized environment. The method may include receiving, from the orchestration system and at the user device, instructions for a second UI that indicates results from the performance test. The method may include transmitting, to the orchestration system and from the user device, second input. The method may include receiving, from the orchestration system and at the user device, instructions for a third UI in response to the second input. The method may include transmitting, to the orchestration system, from the user device, and using the third UI, a configuration for a security test to execute on one or more applications of the computerized environment. The method may include receiving, from the orchestration system and at the user device, instructions for a fourth UI that indicates results from the security test. The method may include transmitting, to the orchestration system and from the user device, third input. The method may include receiving, from the orchestration system and at the user device, instructions for a fifth UI in response to the third input. The method may include transmitting, to the orchestration system, from the user device, and using the fifth UI, a configuration for a data exfiltration test to execute on one or more data stores of the computerized environment. The method may include receiving, from the orchestration system and at the user device, instructions for a sixth UI that indicates results from the data exfiltration test.

Some implementations described herein relate to a non-transitory computer-readable medium that stores a set of instructions for using unified control of testing within a computerized environment. The set of instructions, when executed by one or more processors of a device, may cause the device to receive, from an orchestration system, a form page associated with a performance test, a security test, or a data exfiltration test. The set of instructions, when executed by one or more processors of the device, may cause the device to perform an API call to receive a configuration file that encodes a hash map. The set of instructions, when executed by one or more processors of the device, may cause the device to receive, using a first UI element of the form page, a first portion of a configuration. The set of instructions, when executed by one or more processors of the device, may cause the device to modify a second UI element of the form page based on the first portion of the configuration and the hash map. The set of instructions, when executed by one or more processors of the device, may cause the device to receive, using the second UI element of the form page, a second portion of the configuration. The set of instructions, when executed by one or more processors of the device, may cause the device to transmit, to the orchestration system, the configuration in response to confirmation from a user.

### BRIEF DESCRIPTION OF THE DRAWINGS

FIGS. 1A-1H are diagrams of an example implementation relating to integrated performance and security testing, in accordance with some embodiments of the present disclosure.

FIGS. 2A-2B are diagrams of example UIs associated with creation of, and results from, performance testing, in accordance with some embodiments of the present disclosure.

FIGS. 3A-3C are diagrams of example UIs associated with creation of, and results from, security testing, in accordance with some embodiments of the present disclosure.

FIGS. 4A-4B are diagrams of example UIs associated with creation of, and results from, data exfiltration testing, in accordance with some embodiments of the present disclosure.

FIGS. 5A-5D are diagrams of example UIs associated with viewing details of performance, security, or data exfiltration tests, in accordance with some embodiments of the present disclosure.

FIGS. 6A-6B are diagrams of example UIs associated with agent onboarding, in accordance with some embodiments of the present disclosure.

FIGS. 7A-7G are diagrams of example UIs associated with dynamic page rendering, in accordance with some embodiments of the present disclosure.

FIG. 8 is a diagram of an example environment in which systems and/or methods described herein may be implemented, in accordance with some embodiments of the present disclosure.

FIG. 9 is a diagram of example components of one or more devices of FIG. 8, in accordance with some embodiments of the present disclosure.

FIGS. 10A-10B are a flowchart of an example process relating to integrated performance and security testing, in accordance with some embodiments of the present disclosure.

FIG. 11 is a flowchart of an example process relating to integrated performance and security testing, in accordance with some embodiments of the present disclosure.

### DETAILED DESCRIPTION

The following detailed description of example implementations refers to the accompanying drawings. The same reference numbers in different drawings may identify the same or similar elements.

In a computerized system, cloud instances, applications, and data stores may be deployed. For example, the cloud instances may include operating system (OS) instances created within a cloud computing environment in order to execute the applications and/or provide support to application programming interface (API) functions provisioned by the computerized environment, among other examples. The data stores may include storage instances in the cloud computing environment, standalone remote storages, or a combination thereof. The data stores may support the cloud instances and the applications and/or may be accessible by users of the cloud computing environment. Additionally, the computerized system may interact with workstations (e.g., laptops or tablets, among other examples). For example, users of the workstations may be authorized to interact with (at least some of) the cloud instances, the applications, and the data stores.

Administrators may be tasked with maintaining speed and security of the cloud instances, the applications, and the data stores. However, setting up a test for the computerized environment consumes a significant amount of processing resources and memory. In particular, administrators may generate a configuration file and provide a command to execute the test according to the configuration file. Additionally, administrators usually switch between systems in order to submit different tests, which consumes additional processing resources and memory.

Some implementations described herein enable an integrated system to facilitate execution of performance tests, security tests, data exfiltration tests, and optionally workstation tests from a unified set of UIs. As a result, processing resources and memory are conserved as compared with using separate systems to configure and execute the tests.

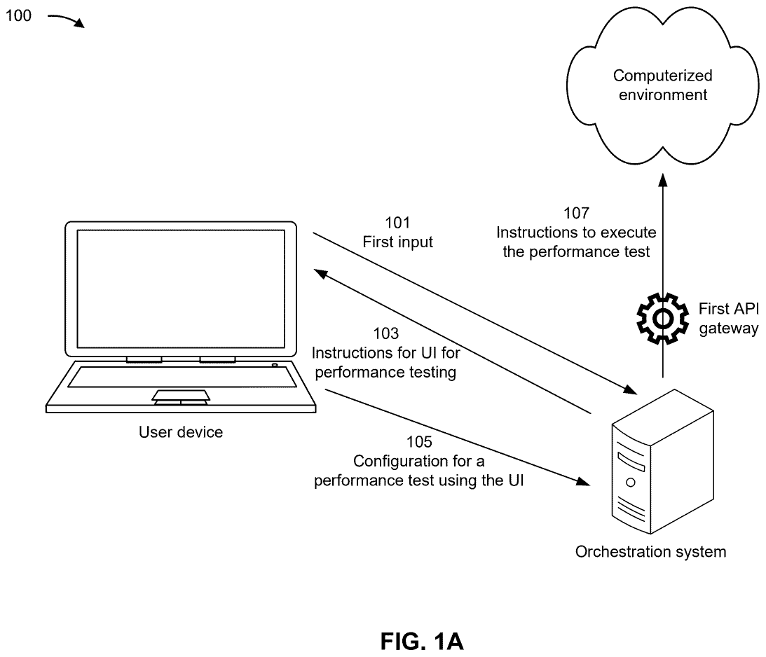

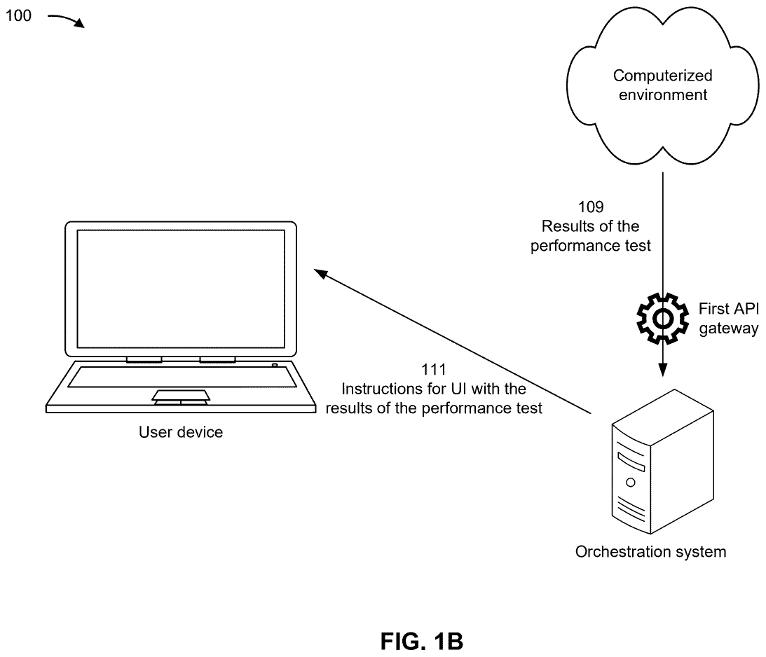

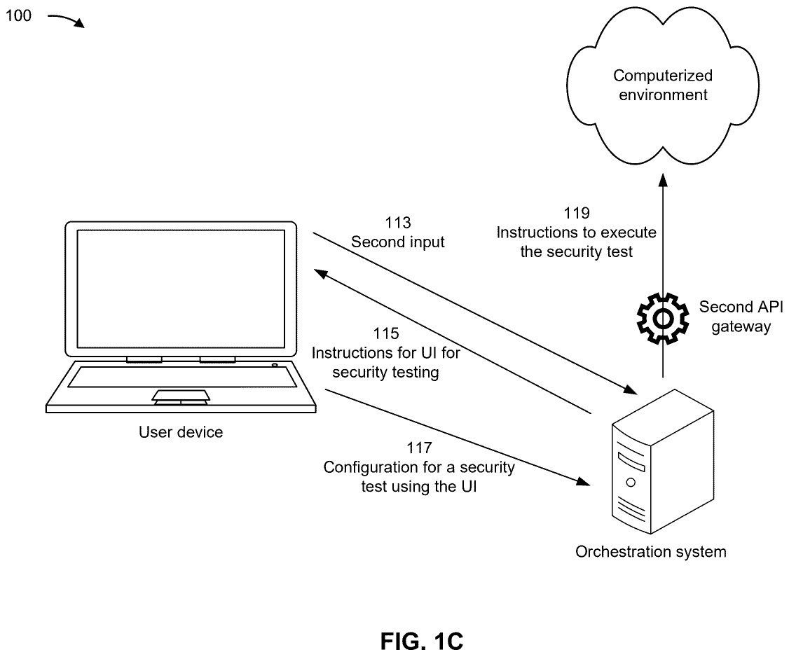

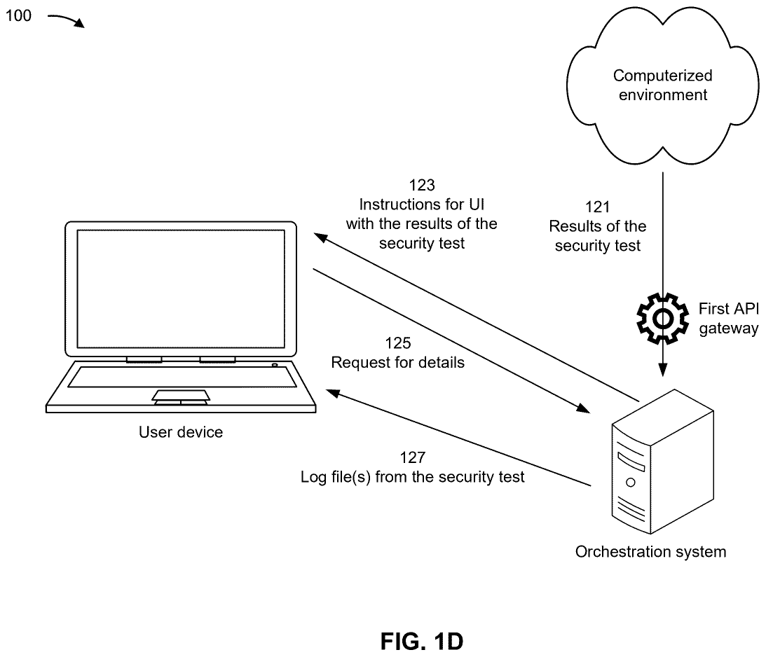

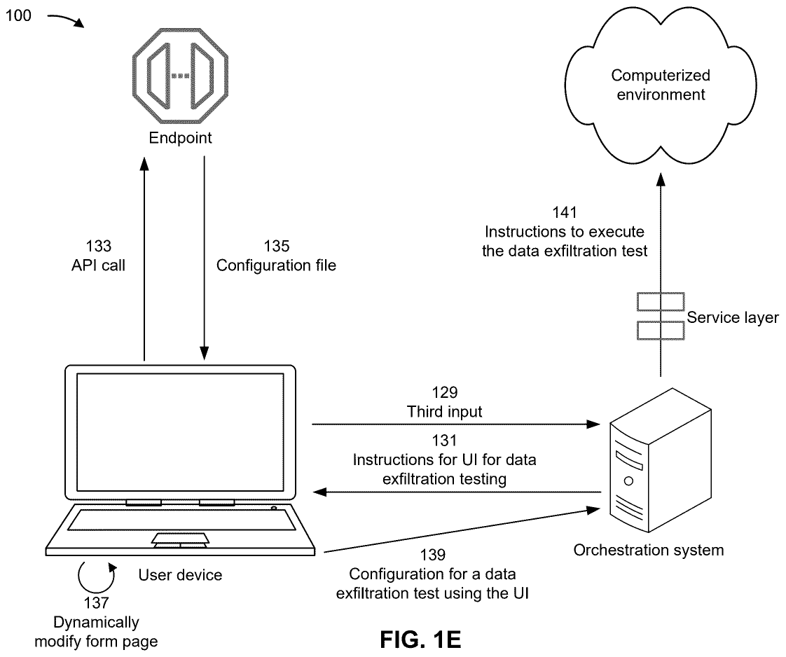

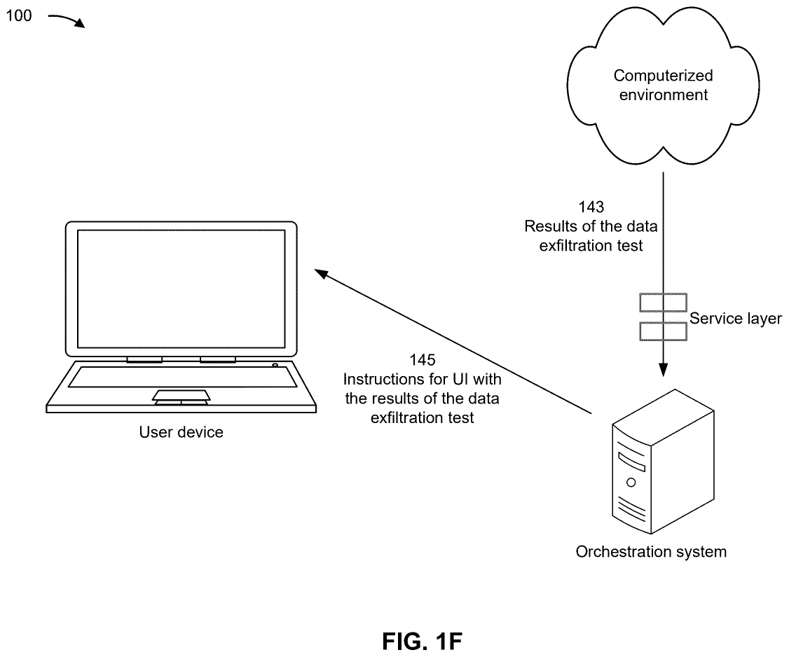

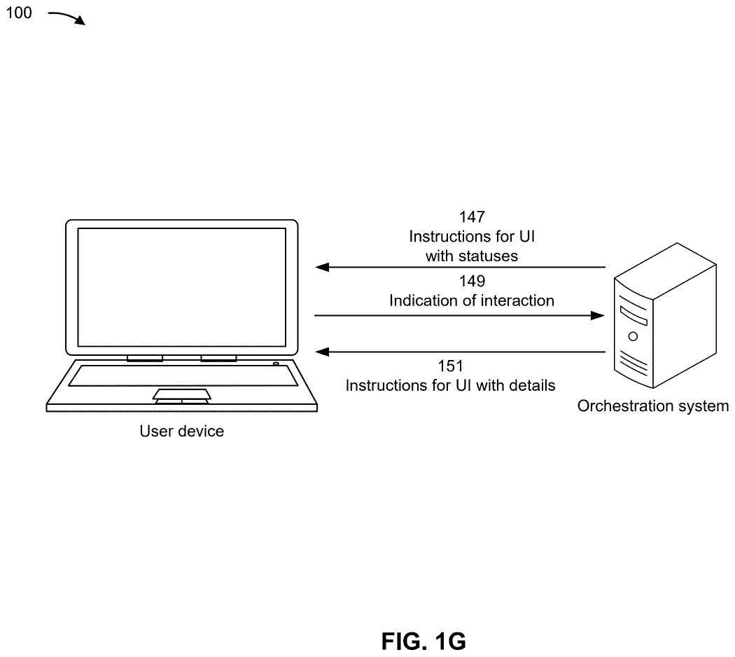

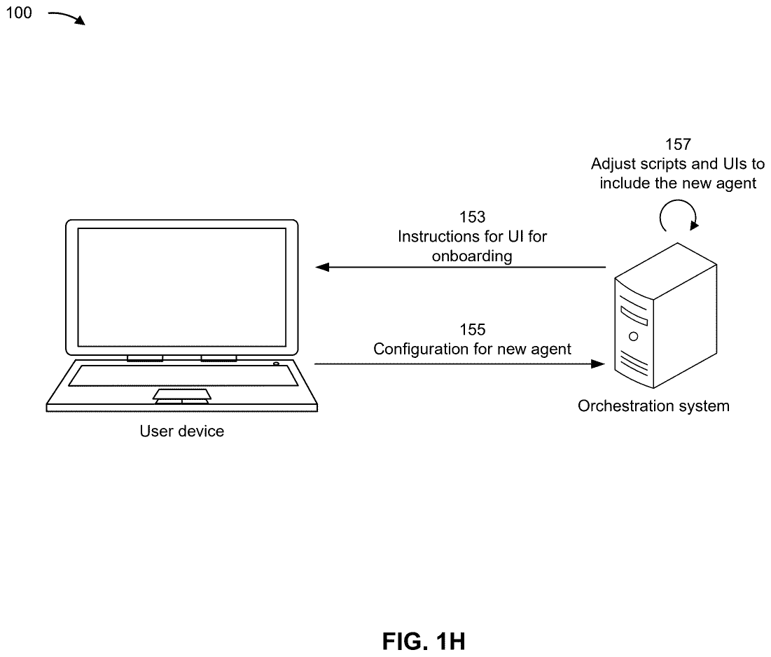

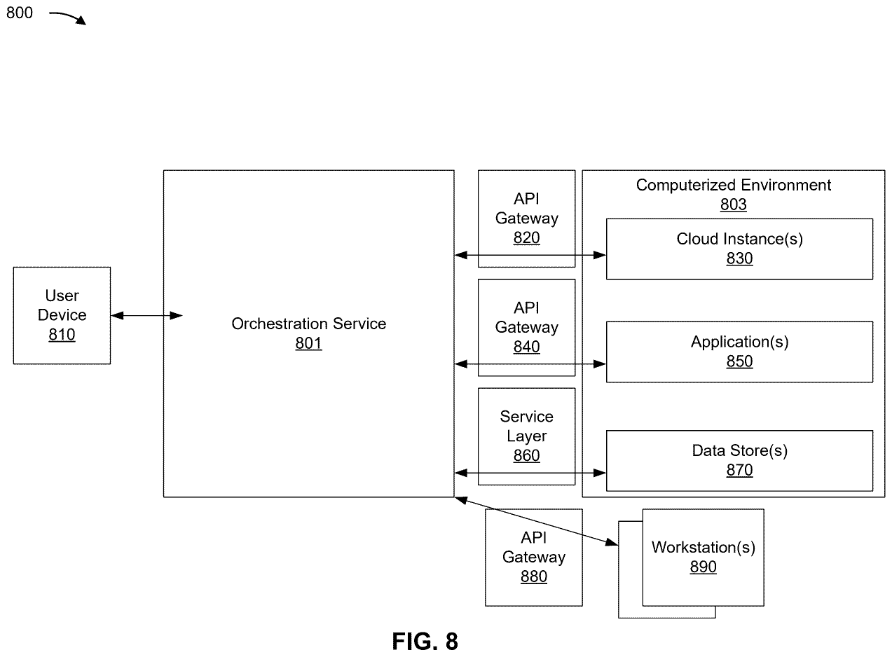

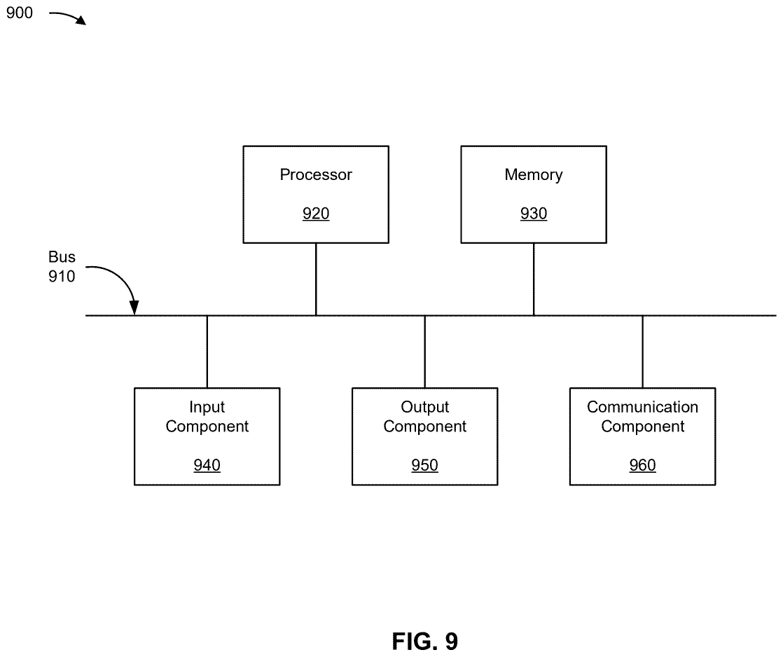

FIGS. 1A-1H are diagrams of an example 100 associated with integrated performance and security testing. As shown in FIGS. 1A-1H, example 100 includes a user device, an orchestration system, and a computerized environment. These devices are described in more detail in connection with FIGS. 8 and 9.

As shown in FIG. 1A and by reference number 101, the user device may transmit, and the orchestration system may receive, first input. For example, a user of the user device may interact with a UI (e.g., via an input component of the user device) to provide the first input. Accordingly, the first input may indicate the interaction from the user. The first input may be associated with a performance test for the computerized environment.

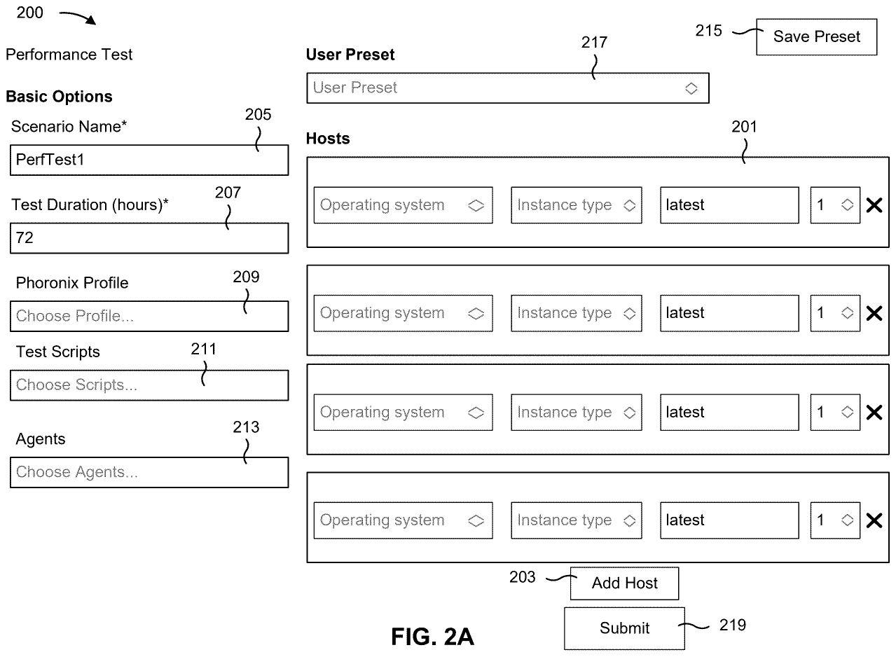

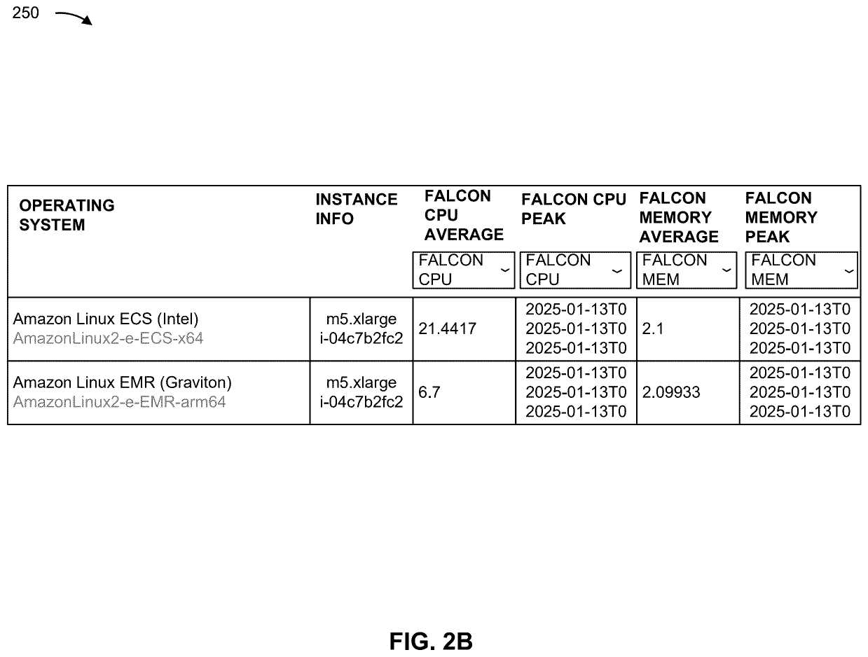

As shown by reference number 103, the orchestration system may output, and the user device may receive, instructions for a first UI. The orchestration system may output, and the user device may receive, the instructions for the first UI in response to the first input. The first UI may include a set of UI elements for configuring one or more cloud computing instances, as described below in connection with FIG. 2A. The user device may output the first UI using an output component.

As shown by reference number 105, the user device may transmit, and the orchestration system may receive, a configuration for a performance test to execute within one or more cloud computing instances of the computerized environment. For example, the configuration may be based on the first UI. The user may indicate the configuration using elements of the first UI and may trigger the user device to transmit the configuration using a button of the first UI, as described below in connection with FIG. 2A. By using the first UI to receive the configuration, the orchestration system reduces latency associated with configuration of the performance test (e.g., as compared with using text input to receive the configuration).

As shown by reference number 107, the orchestration system may transmit, using a first API gateway, instructions to execute the performance test. For example, the orchestration system may transmit, and the computerized system may receive, the instructions to execute the performance test. The instructions to execute the performance test may include instructions to boot up and monitor the cloud computing instance(s).

As shown in FIG. 1B and by reference number 109, the computerized system may output, using the first API gateway, results from the performance test. For example, the computerized system may output, and the orchestration system may receive, the results from the performance test.

As shown by reference number 111, the orchestration system may output, and the user device may receive, instructions for a second UI. The second UI may indicate the results from the performance test. The second UI may include a table with the results sorted by the cloud computing instance(s), as described below in connection with FIG. 2B. The user device may output the second UI using an output component. By using the second UI to provide the results, the orchestration system conserves processing resources and memory that otherwise would have been used by the user device in sifting through log files or other raw output of the results.

As shown in FIG. 1C and by reference number 113, the user device may transmit, and the orchestration system may receive, second input. For example, a user of the user device may interact with a UI (e.g., via an input component of the user device) to provide the second input. Accordingly, the second input may indicate the interaction from the user. The second input may be associated with a security test for the computerized environment. By allowing the user device to move from configuring the performance test to configuring the security test with a single interaction (or just a few interactions), the orchestration system conserves processing resources and memory that otherwise would have been spent on the user device moving from one system that executes the performance test to a different system that executes the security test.

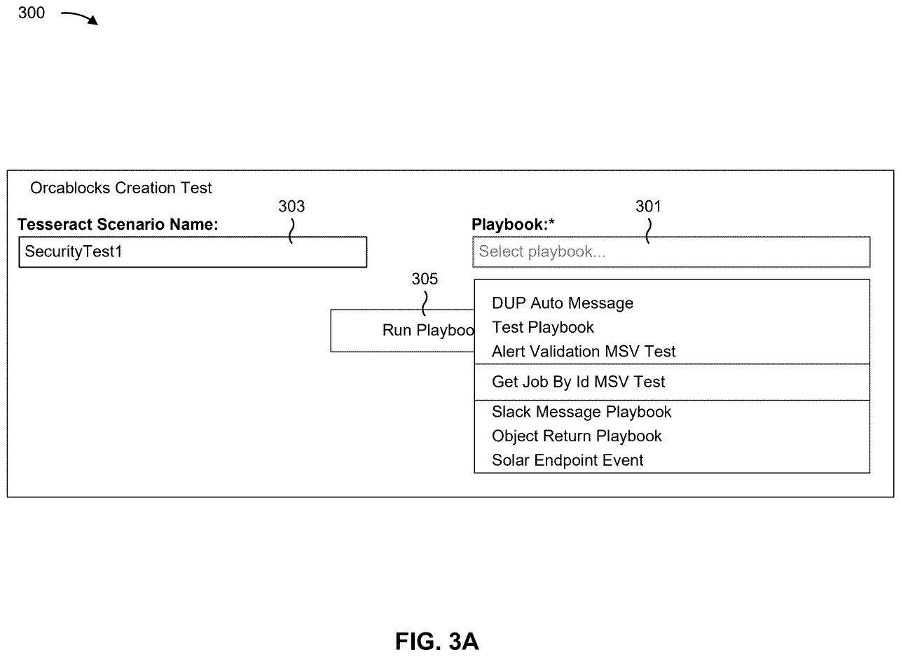

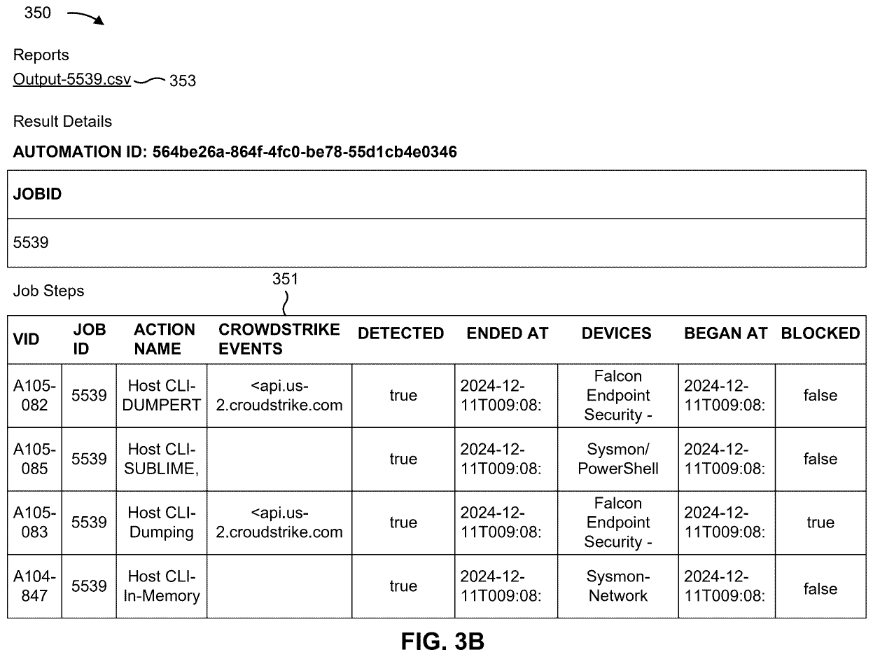

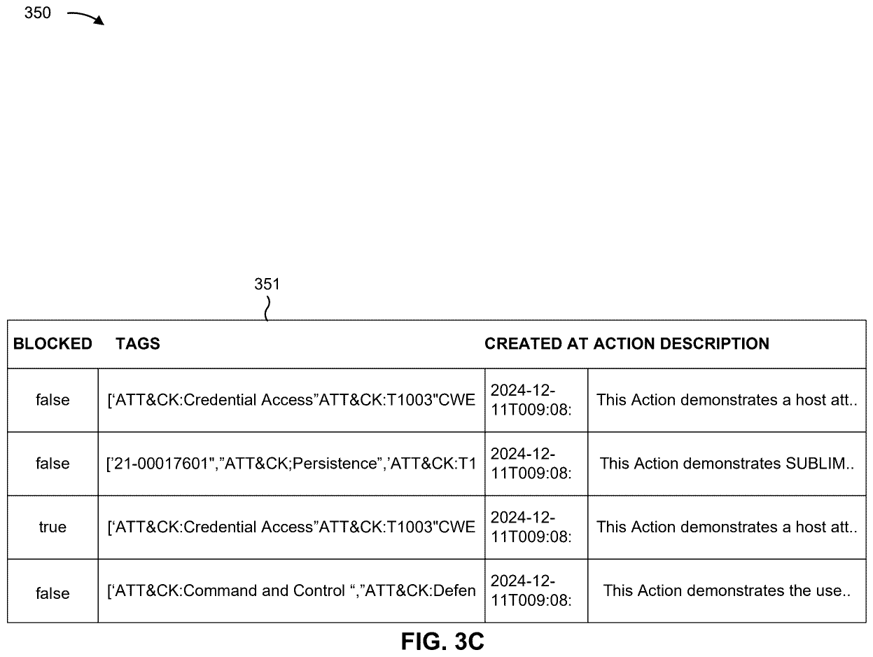

As shown by reference number 115, the orchestration system may output, and the user device may receive, instructions for a third UI. The orchestration system may output, and the user device may receive, the instructions for the third UI in response to the second input. The third UI may include a selector for choosing the security test from a plurality of possible security tests, as described below in connection with FIG. 3A. The user device may output the third UI using an output component.

As shown by reference number 117, the user device may transmit, and the orchestration system may receive, a configuration for a security test to execute on one or more applications of the computerized environment. For example, the configuration may be based on the third UI. The user may indicate the configuration using elements of the third UI and may trigger the user device to transmit the configuration using a button of the third UI, as described below in connection with FIG. 3A. By using the third UI to receive the configuration, the orchestration system reduces latency associated with configuration of the security test (e.g., as compared with using text input to receive the configuration).

As shown by reference number 119, the orchestration system may transmit, using a second API gateway, instructions to execute the security test. For example, the orchestration system may transmit, and the computerized system may receive, the instructions to execute the security test. The instructions to execute the security test may include instructions to execute a script of actions in the computerized environment.

As shown in FIG. 1D and by reference number 121, the computerized system may output, using the second API gateway, results from the security test. For example, the computerized system may output, and the orchestration system may receive, the results from the security test.

As shown by reference number 123, the orchestration system may output, and the user device may receive, instructions for a fourth UI. The fourth UI may indicate the results from the security test. The second UI may include a table with the results sorted by actions included in the security test, as described below in connection with FIGS. 3B-3C. The user device may output the fourth UI using an output component. By using the fourth UI to provide the results, the orchestration system conserves processing resources and memory that otherwise would have been used by the user device in sifting through log files or other raw output of the results.

In some aspects, the user device may request at least one log file associated with the results of the security test. For example, as shown by reference number 125, the user device may transmit, and the orchestration system may receive, a request for additional details. For example, a user of the user device may interact with a hyperlink of the fourth UI (e.g., via an input component of the user device) to trigger the user device to transmit the request, as described below in connection with FIG. 3B. As shown by reference number 127, the orchestration system may transmit, and the user device may receive, the log file(s) associated with the results of the security test. The orchestration system may transmit, and the user device may receive, the log file(s) in response to the request for additional details.

As shown in FIG. 1E and by reference number 129, the user device may transmit, and the orchestration system may receive, third input. For example, a user of the user device may interact with a UI (e.g., via an input component of the user device) to provide the third input. Accordingly, the third input may indicate the interaction from the user. The third input may be associated with a data exfiltration test for the computerized environment. By allowing the user device to move from configuring the security test to configuring the data exfiltration test with a single interaction (or just a few interactions), the orchestration system conserves processing resources and memory that otherwise would have been spent on the user device moving from one system that executes the security test to a different system that executes the data exfiltration test.

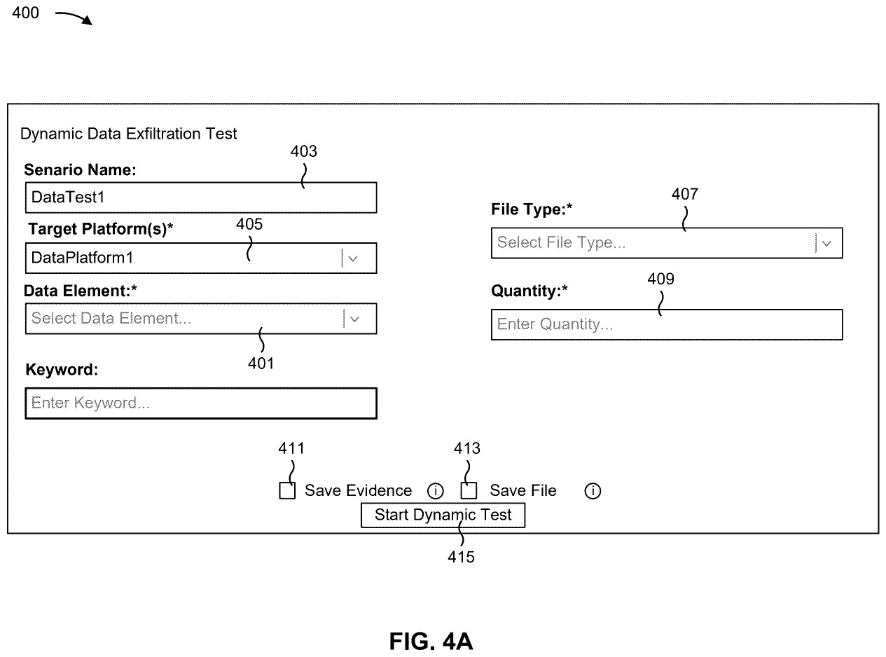

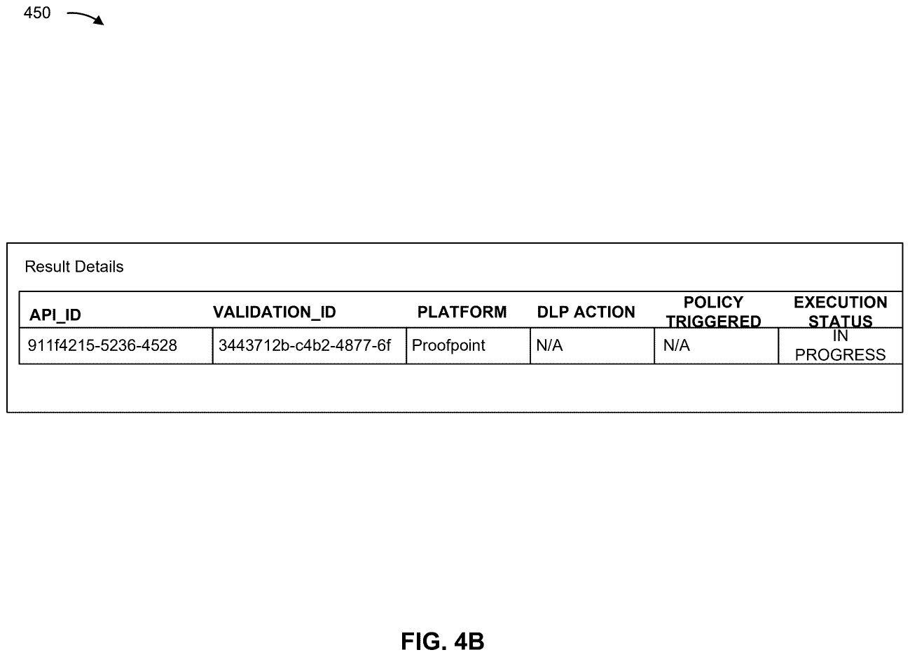

As shown by reference number 131, the orchestration system may output, and the user device may receive, instructions for a fifth UI. The orchestration system may output, and the user device may receive, the instructions for the fifth UI in response to the third input. The fifth UI may include a selector for choosing a data element for the data exfiltration test, as described below in connection with FIG. 4A. The user device may output the fifth UI using an output component.

In some implementations, the fifth UI may include a form page associated with the data exfiltration test. The user device may perform an API call, as shown by reference number 133, to receive a configuration file that encodes a hash map, as shown by reference number 135. The API call may be to an endpoint that is separate from the orchestration system. As a result, options for the form page may be updated without updating the orchestration system, which conserves processing resources and memory that otherwise would have been consumed in rebuilding code for the form page.

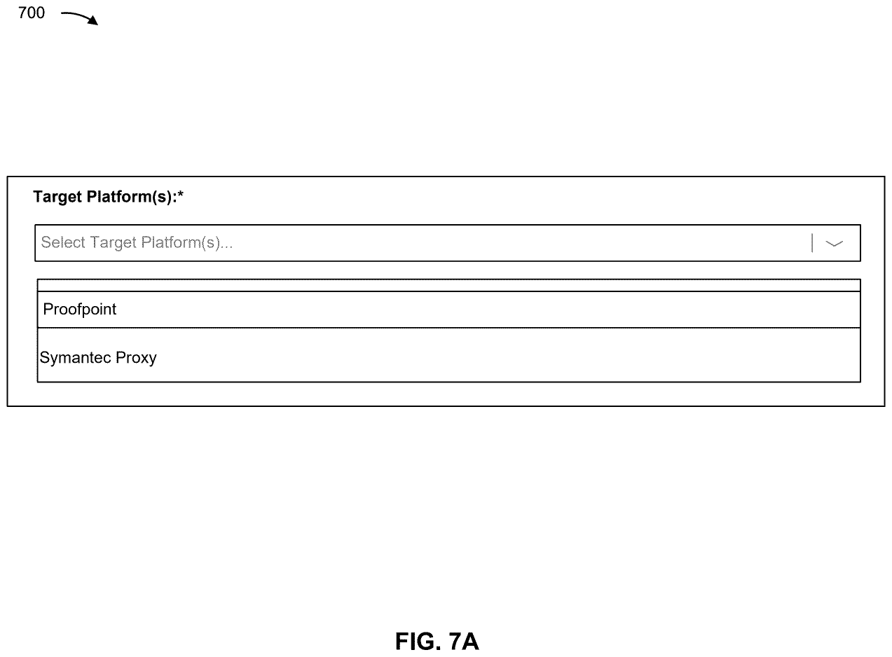

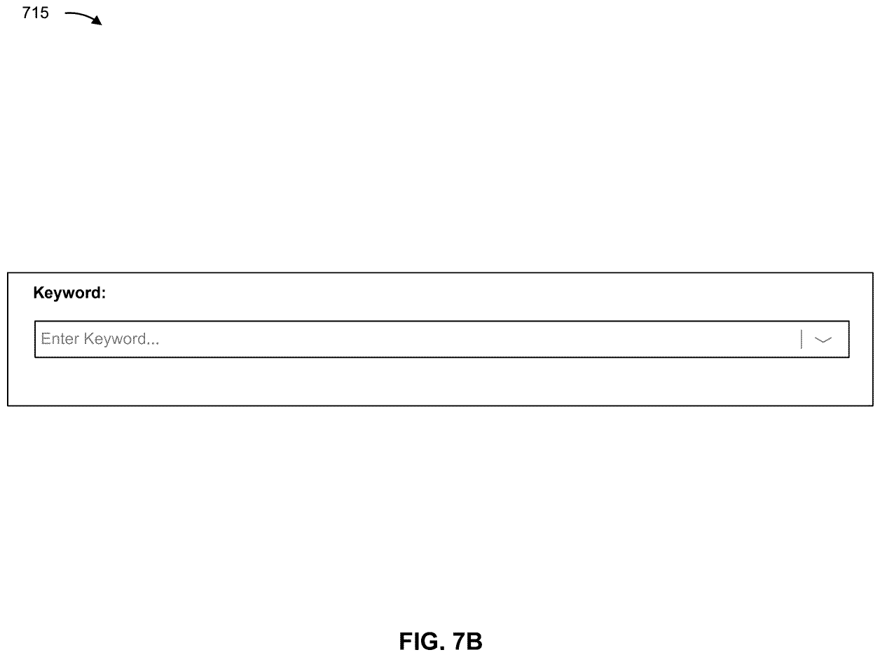

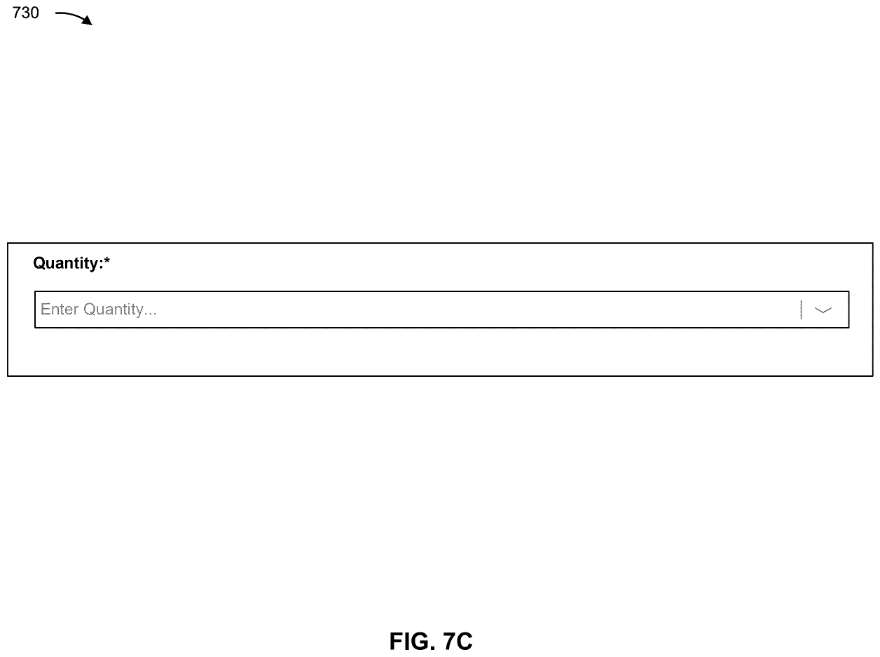

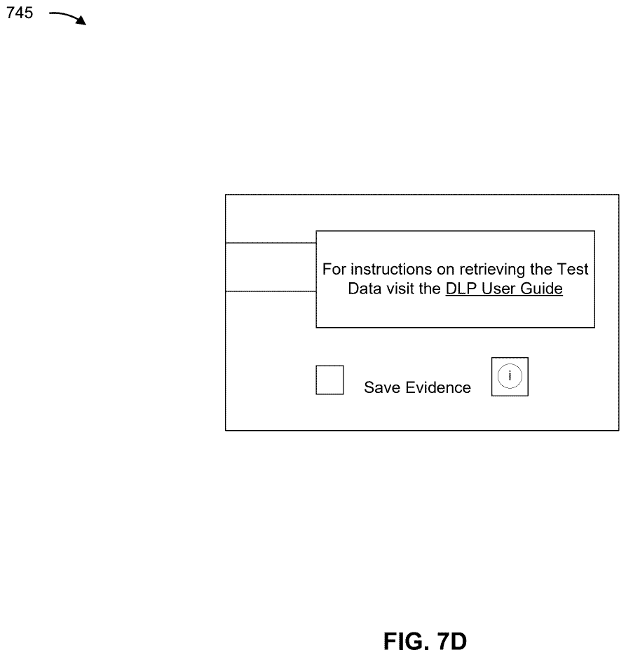

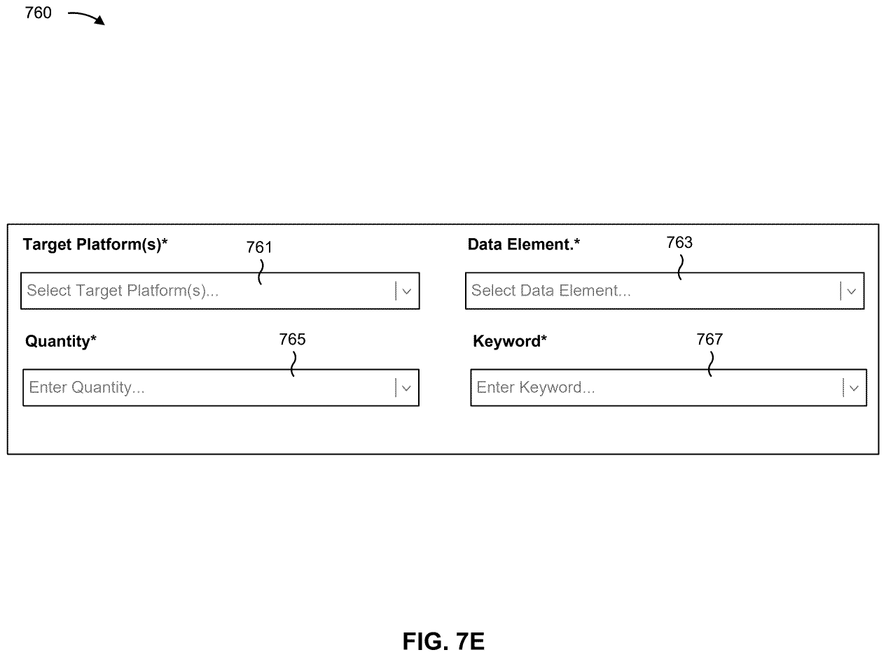

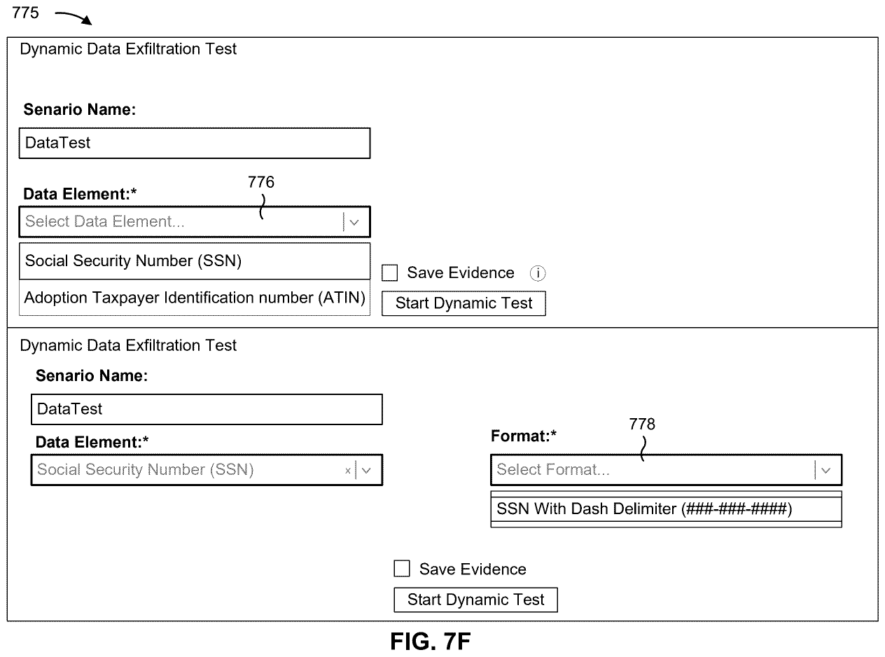

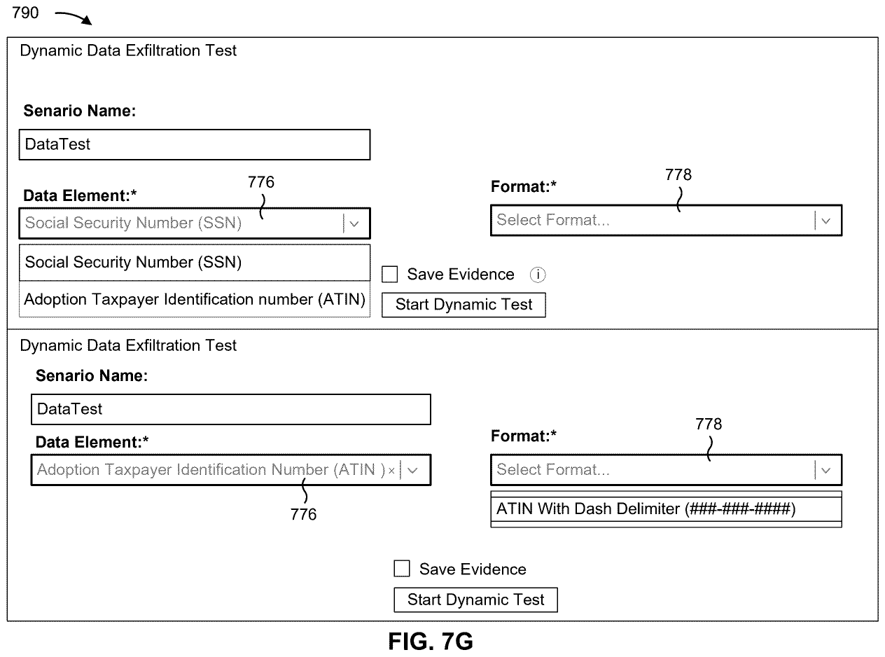

The hash map may define options for UI elements, as described below in connection with FIGS. 7A-7E. In some implementations, the configuration file may be an extensible markup language (XML) file or a JavaScript® object notation (JSON) file. As shown by reference number 137, the user device may dynamically modify the form page as the user provides a configuration for the data exfiltration test. For example, the user device may receive, using a first UI of the form page, a first portion of the configuration and may modify a second UI element of the form page based on the first portion of the configuration and the hash map. In one example, as described below in connection with FIG. 7F, the user device may make the second UI element visible in response to receiving the first portion of the configuration. In another example, as described below in connection with FIG. 7G, the user device may load options for the second UI element based on the hash map and the first portion of the configuration. Therefore, the user device may receive, using the second UI element of the form page, a second portion of the configuration for the data exfiltration test. As described in connection with FIG. 4A, the user device may transmit the configuration to the orchestration system in response to confirmation from the user.

Although the example 100 includes the form page associated with the data exfiltration test, other examples may additionally, or alternatively, include a form page associated with a performance test, a security test, or a workstation performance test.

As shown by reference number 139, the user device may transmit, and the orchestration system may receive, a configuration for a data exfiltration test to execute on one or more data stores of the computerized environment. For example, the configuration may be based on the fifth UI. The user may indicate the configuration using elements of the fifth UI and may trigger the user device to transmit the configuration using a button of the fifth UI, as described below in connection with FIG. 4A. By using the fifth UI to receive the configuration, the orchestration system reduces latency associated with configuration of the data exfiltration test (e.g., as compared with using text input to receive the configuration).

As shown by reference number 141, the orchestration system may transmit, using a service layer, instructions to execute the data exfiltration test. For example, the orchestration system may transmit, and the computerized system may receive, the instructions to execute the data exfiltration test. The instructions to execute the data exfiltration test may include instructions to search files, stored in the data store(s) of the computerized environment, for patterns and/or keywords (e.g., indicated by the configuration).

As shown in FIG. 1D and by reference number 143, the computerized system may output, using the service layer, results from the data exfiltration test. For example, the computerized system may output, and the orchestration system may receive, the results from the data exfiltration test.

As shown by reference number 145, the orchestration system may output, and the user device may receive, instructions for a sixth UI. The sixth UI may indicate the results from the data exfiltration test. The sixth UI may include a list of files or a list of endpoints that failed the data exfiltration test, as described below in connection with FIG. 4B. The user device may output the sixth UI using an output component. By using the sixth UI to provide the results, the orchestration system conserves processing resources and memory that otherwise would have been used by the user device in sifting through log files or other raw output of the results.

Although the example 100 is described in connection with performance tests, security tests, and data exfiltration tests, other examples may additionally, or alternatively, include workstation performance tests. For example, the user device may transmit a configuration for a workstation performance test to execute on one or more workstations (that interact with the computerized environment), and the orchestration system may transmit instructions to the workstation(s), via the computerized environment, to execute the workstation performance test. The orchestration system may receive results of the workstation performance test and provide the results to the user device.

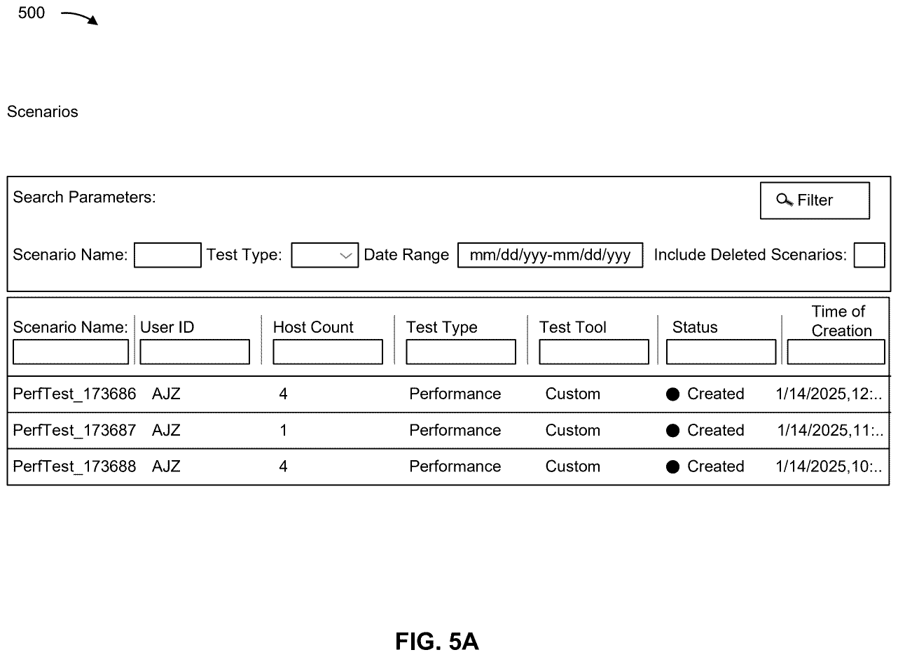

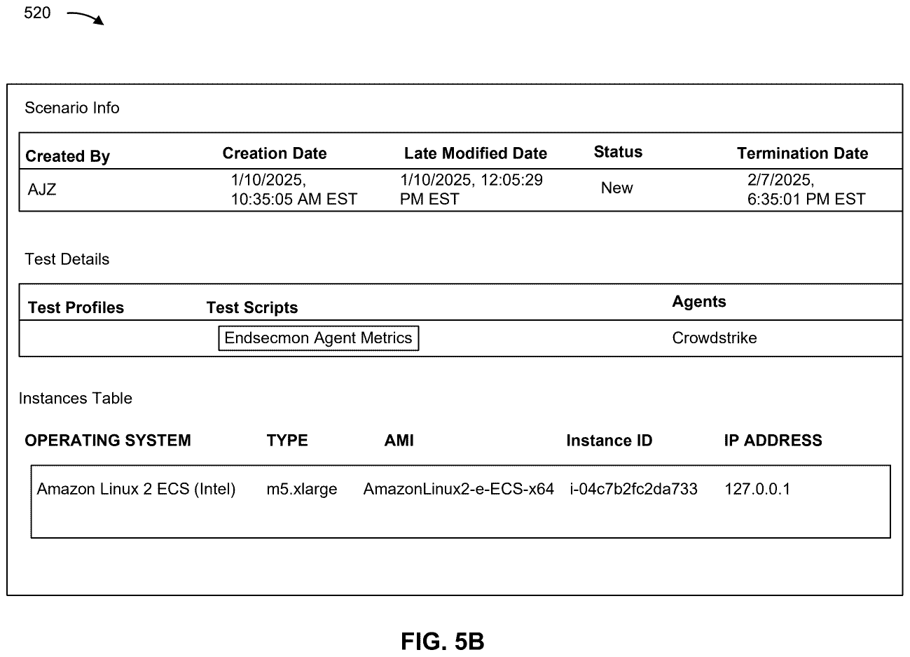

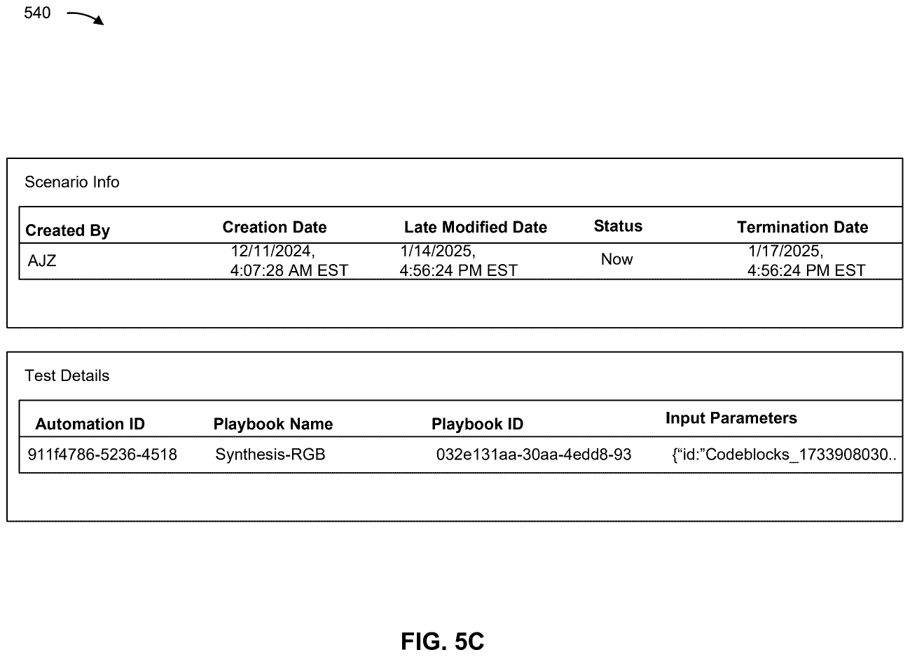

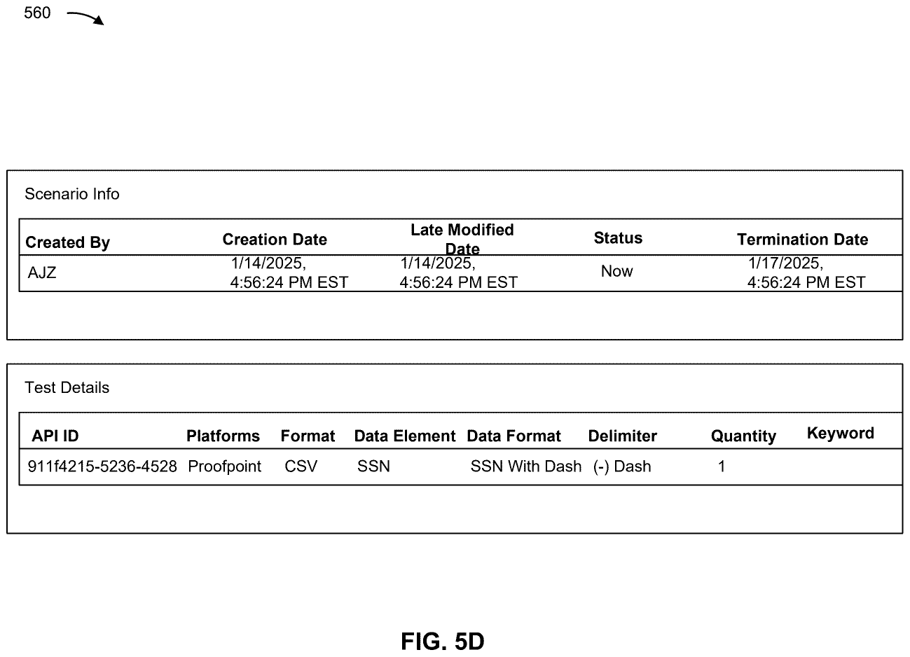

In some implementations, the user may view statuses of any performance tests, security tests, data exfiltration tests, and (optionally) workstation performance tests executed by the orchestration system. For example, as shown in FIG. 1G and by reference number 147, the orchestration system may output, and the user device may receive, instructions for a seventh UI that indicates the performance test, the security test, and the data exfiltration test along with corresponding statuses. The seventh UI may be a table, as described in connection with FIG. 5A.

As shown by reference number 149, the user device may transmit, and the orchestration system may receive, an indication of an interaction with the seventh UI. For example, the user may interact with a row in the seventh UI representing one of the tests. The indication may identify the test associated with the row that was interacted with. As shown by reference number 151, the orchestration system may output, and the user device may receive, instructions for an eighth UI that indicates details of the performance test, the security test, or the data exfiltration test. The eighth UI may be as described in connection with FIG. 5B, FIG. 5C, or FIG. 5D.

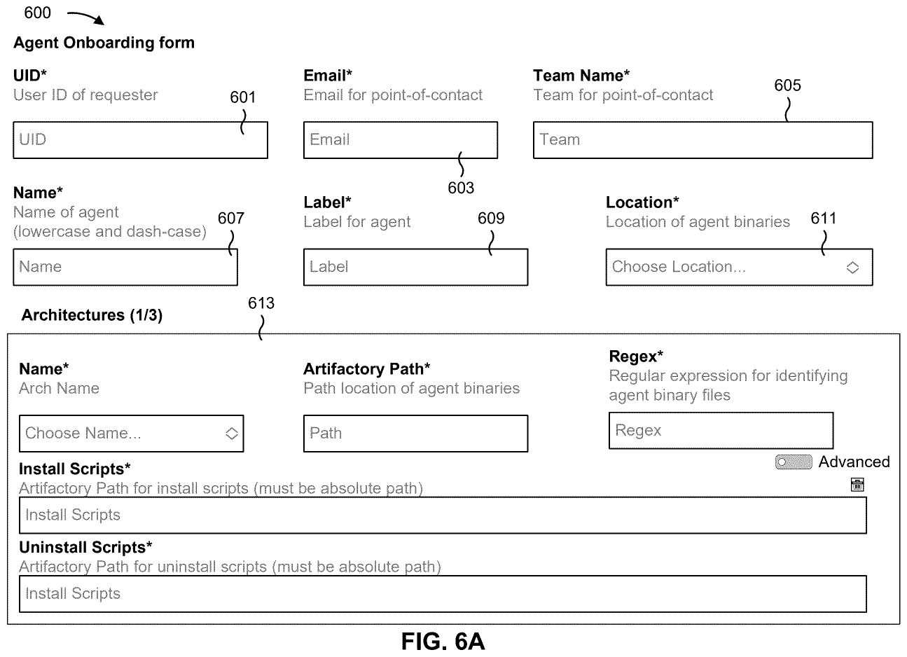

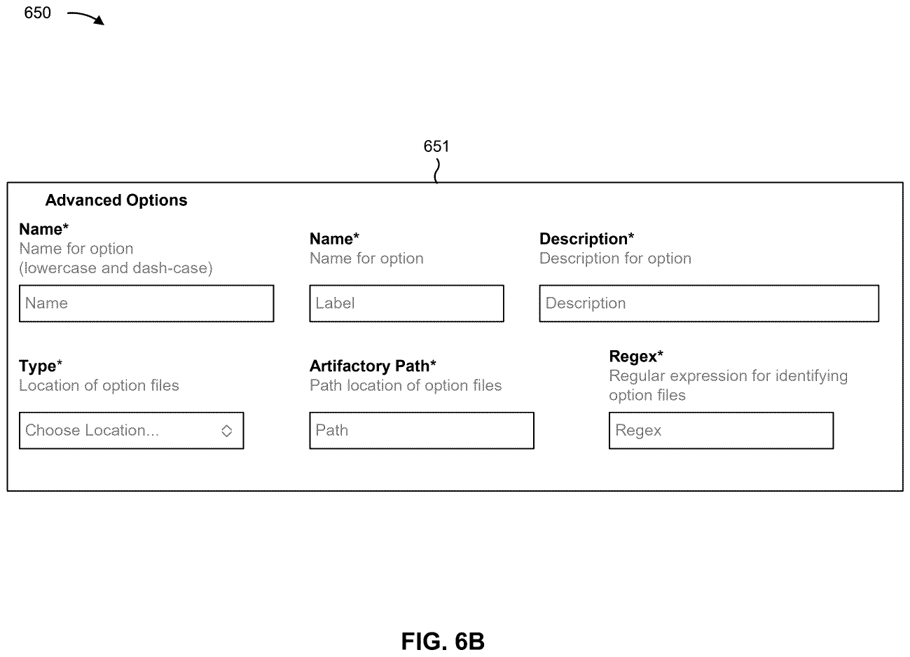

In some implementations, the user may onboard a new agent for performance tests, security tests, data exfiltration tests, or (optionally) workstation performance tests. For example, as shown in FIG. 1H and by reference number 153, the orchestration system may output, and the user device may receive, instructions for a UI for onboarding a new agent. The UI may be as described in connection with FIGS. 6A-6B.

As shown by reference number 155, the user device may transmit, and the orchestration system may receive, a configuration for the new agent. For example, the user may interact with the UI to provide the configuration. As shown by reference number 157, the orchestration system may adjust scripts and UIs to incorporate the new agent. In some implementations, the orchestration system may incorporate the new agent automatically. Alternatively, an administrator may review and approve the new agent, and the orchestration system may incorporate the new agent in response to approval from the administrator.

As indicated above, FIGS. 1A-1H are provided as an example. Other examples may differ from what is described with regard to FIGS. 1A-1H.

FIGS. 2A and 2B are diagrams of example UIs 200 and 250, respectively, associated with creation of, and results from, performance testing. The example UIs 200 and 250 may be output by a user device based on instructions from an orchestration system. These devices are described in more detail in connection with FIGS. 8 and 9.

As shown in FIG. 2A, the example UI 200 may include a set of UI elements 201 for configuring a cloud computing instance for executing a performance test. In FIG. 2A, the set of UI elements 201 may include a drop-down menu for selecting an OS, a drop-down menu for selecting an instance type, a drop-down menu for selecting a version, and a drop-down menu for selecting a quantity of instances to initiate. Additional sets of UI elements may be added to configure additional cloud computing instances using a button 203.

As further shown in FIG. 2A, the example UI 200 may include a text box 205 for providing a name for the performance test, a text box 207 for providing a duration for the performance test, a drop-down menu 209 for selecting a profile for the performance test, a drop-down menu 211 for selecting a script for the performance test, and a drop-down menu 213 for selecting an agent for the performance test.

In some implementations, the example UI 200 may include a button 215 to allow a user to save a configuration entered using the example UI 200. Accordingly, the user may use a drop-down menu 217 to recall a saved configuration at a later time. For example, selection of a saved configuration from the drop-down menu 217 may cause other elements of the example UI 200 to auto-fill based on the saved configuration. The example UI 200 may also include a button 219 that the user may use to trigger transmission (e.g., to the orchestration system) of a configuration based on elements in the example UI 200.

As shown in FIG. 2B, the example UI 250 may include a table with results of the performance test sorted by cloud computing instance. For example, the table may include an average central processing unit (CPU) usage, a peak CPU usage, an average memory usage, and/or a peak memory usage, among other examples.

As indicated above, FIGS. 2A-2B are provided as an examples. Other examples may differ from what is described with regard to FIGS. 2A-2B. For example, some input elements (e.g., drop-down menus or text boxes) may be substituted with other input elements (e.g., checkboxes or radio buttons, among other examples).

FIGS. 3A and 3B-3C are diagrams of example UIs 300 and 350, respectively, associated with creation of, and results from, security testing. The example UIs 300 and 350 may be output by a user device based on instructions from an orchestration system. These devices are described in more detail in connection with FIGS. 8 and 9.

As shown in FIG. 3A, the example UI 300 may include a selector 301 for choosing a security test from a plurality of possible security tests. As further shown in FIG. 3A, the example UI 300 may include a text box 303 for providing a name for the security test. In some implementations, the example UI 300 may include a button 305 that the user may use to trigger transmission (e.g., to the orchestration system) of a configuration based on elements in the example UI 300.

As shown in FIGS. 3B-3C, the example UI 350 may include a table 351 with results of the security test sorted by actions included in the security test. For example, the table 351 may indicate a start time for an action, an end time for the action, a name of the action, a device on which the action was taken, whether the action was detected, whether the action was blocked, a tag associated with the action, a description associated with the action, and a creation time of a log entry associated with the action. As further shown in FIG. 3B, the example UI 350 may include a hyperlink 353 that the user may use to request a log file (e.g., at least one file log) associated with the results of the security test.

As indicated above, FIGS. 3A-3C are provided as an examples. Other examples may differ from what is described with regard to FIGS. 3A-3C. For example, some input elements (e.g., drop-down menus, text boxes, or hyperlinks) may be substituted with other input elements (e.g., checkboxes, radio buttons, or buttons, among other examples).

FIGS. 4A and 4B are diagrams of example UIs 400 and 450, respectively, associated with creation of, and results from, data exfiltration testing. The example UIs 400 and 450 may be output by a user device based on instructions from an orchestration system. These devices are described in more detail in connection with FIGS. 8 and 9.

As shown in FIG. 4A, the example UI 400 may include a selector 401 for choosing a data element for the data exfiltration test. As further shown in FIG. 4A, the example UI 400 may include a text box 403 for providing a name for the data exfiltration test, a drop-down menu 405 for selecting a platform for the data exfiltration test, a drop-down menu 407 for selecting a file type for the data exfiltration test, and a text box 409 for entering a number of times to execute the data exfiltration test.

As further shown in FIG. 4A, the example UI 400 may include a checkbox 411 to trigger saving of sensitive information detected by the data exfiltration test (e.g., to a log file). Additionally, or alternatively, the example UI 400 may include a checkbox 413 to trigger saving copies of files detected by the data exfiltration test. In some implementations, the example UI 400 may include a button 415 that the user may use to trigger transmission (e.g., to the orchestration system) of a configuration based on elements in the example UI 400.

As shown in FIG. 4B, the example UI 450 may include a table with a list of files or a list of endpoints scanned during the data exfiltration test. For example, the table may include a platform with a file or endpoint, an action taken for the file or endpoint, a policy triggered for the file or endpoint, and a status of the data exfiltration test for the file or endpoint.

As indicated above, FIGS. 4A-4B are provided as an examples. Other examples may differ from what is described with regard to FIGS. 4A-4B. For example, some input elements (e.g., drop-down menus, text boxes, or checkboxes) may be substituted with other input elements (e.g., radio buttons, among other examples).

FIGS. 5A, 5B, 5C, and 5D are diagrams of example UIs 500, 520, 540, and 560, respectively, associated with viewing details of performance, security, or data exfiltration tests. The example UIs 500, 520, 540, and 560 may be output by a user device based on instructions from an orchestration system. These devices are described in more detail in connection with FIGS. 8 and 9.

As shown in FIG. 5A, the example UI 500 may include a table with a list of tests. For example, the table may include names associated with the tests, users who initiated the tests, times of creation for the tests, and types and statuses of the tests. The example UI 500 may further include filters that a user may select to sort rows representing the list of tests.

As shown in FIG. 5B, the example UI 520 may include details about a performance test. As shown in FIG. 5C, the example UI 540 may include details about a security test. As shown in FIG. 5D, the example UI 560 may include details about a data exfiltration test.

As indicated above, FIGS. 5A-5D are provided as an examples. Other examples may differ from what is described with regard to FIGS. 5A-5D.

FIGS. 6A and 6B are diagrams of example UIs 600 and 650, respectively, associated with agent onboarding. The example UIs 600 and 650 may be output by a user device based on instructions from an orchestration system. These devices are described in more detail in connection with FIGS. 8 and 9.

As shown in FIG. 6A, the example UI 600 may include a set of UI elements for identifying a user submitting a new agent (e.g., text box 601 for a username, text box 603 for an email address, and text box 605 for a team name) and a set of UI elements for identifying the new agent (e.g., text box 607 for a name, text box 609 for a label, and text box 611 for a location). Additionally, the example UI 600 may include a set of UI elements 613 for configuring the new agent for a specific architecture (e.g., identifying scripts and regular expressions (regexes) to apply). As shown in FIG. 6B, the example UI 650 may include a set of UI elements 651 for additional details for the new agent (e.g., identifying files and regexes for provide options for execution of the new agent).

As indicated above, FIGS. 6A-6B are provided as an examples. Other examples may differ from what is described with regard to FIGS. 6A-6B.

FIGS. 7A, 7B, 7C, 7D, 7E, 7F, and 7G are diagrams of example UIs 700, 715, 730, 745, 760, 775, and 790, respectively, associated with dynamic page rendering. The example UIs 700, 715, 730, 745, 760, 775, and 790 may be output by a user device based on instructions from an orchestration system. These devices are described in more detail in connection with FIGS. 8 and 9.

As shown in FIG. 7A, the example UI 700 may include a drop-down menu with options that are defined in a configuration file (e.g., from an API endpoint separate from the orchestration system providing a form page with the example UI 700). As shown in FIG. 7B, the example UI 715 may include a text box with an input type (e.g., string) defined in the configuration file. As shown in FIG. 7C, the example UI 730 may include a text box with an input type (e.g., integer) defined in the configuration file. As shown in FIG. 7D, the example UI 745 may include a button that triggers a pop-up window that includes text provided in the configuration file. As shown in FIG. 7E, the example UI 760 may include a sequence of input elements (e.g., drop-down menu 761, drop-down menu 763, text box 765, and text box 767) that appear in an order indicated in the configuration file. For example, the drop-down menu 763 may appear after input is provided via the drop-down menu 761, the text box 765 may appear after input is provided via the drop-down menu 763, and the text box 767 may appear after input is provided via the text box 765.

As shown in FIG. 7F, the example UI 775 may include a first drop-down menu 776. After input is provided via the first drop-down menu 776, a second drop-down menu 778 may appear. Additionally, or alternatively, options for the second drop-down menu 778 may be populated, based on the configuration file, in response to a selection from the first drop-down menu 776. Alternatively, as shown in FIG. 7G, the second drop-down menu 778 may remain visible but may have options populated based on a selection from the first drop-down menu 776.

As indicated above, FIGS. 7A-7G are provided as an examples. Other examples may differ from what is described with regard to FIGS. 7A-7G.

FIG. 8 is a diagram of an example environment 800 in which systems and/or methods described herein may be implemented. As shown in FIG. 8, environment 800 may include an orchestration service 801, a computerized environment 803, and a user device 810. A first API gateway 820 may connect the orchestration service 801 to one or more cloud instances 830 of the computerized environment 803, and a second API gateway 840 connect the orchestration service 801 to one or more applications 850 of the computerized environment 803. A service layer 860 may connect the orchestration service 801 to one or more data stores 870 of the computerized environment 803. A third API gateway 880 may connect the orchestration service 801 to one or more workstations 890 associated with the computerized environment 803. Devices of environment 800 may interconnect via wired connections, wireless connections, or a combination of wired and wireless connections.

The orchestration service 801 may include one or more servers configured to interact with the user device 810 and the computerized environment 803. Accordingly, the orchestration service 801 may be referred to as an “orchestration system.” Additionally, or alternatively, the orchestration service 801 may be implemented in a cloud computing environment.

The computerized environment 803 may include a cloud computing system authorized for use by one or more users of the workstation(s) 890. The computerized environment 803 may support the cloud instance(s) 830, which may in turn support the application(s) 850. Additionally, the computerized environment 803 may support the data store(s) 870 for use by the application(s) 850 and/or the workstation(s) 890.

The API gateways 820, 840, and 880 may each provide an endpoint for the orchestration service 801 to provide instructions (e.g., for performance tests, security tests, and/or workstation performance tests). Similarly, the service layer 860 may provide the orchestration service 801 access to the data store(s) 870 (e.g., for scanning and searching as well as remediation according to a data exfiltration test).

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

FIG. 9 is a diagram of example components of a device 900 associated with integrated performance and security testing. The device 900 corresponds to one or more of an orchestration service 801, a computerized environment 803, and/or a user device 810. In some implementations, an orchestration service 801, a computerized environment 803, and/or a user device 810 may include one or more devices 900 and/or one or more components of the device 900. In the example shown in FIG. 9, the device 900 includes a bus 910, a processor 920, a memory 930, an input component 940, an output component 950, and/or a communication component 960.

The bus 910 includes one or more components that enable wired and/or wireless communication among the components of the device 900. The bus 910 couples together two or more components of FIG. 9, such as via operative coupling, communicative coupling, electronic coupling, and/or electric coupling. For example, the bus 910 may include an electrical connection (e.g., a wire, a trace, and/or a lead) and/or a wireless bus. The processor 920 includes a central processing unit, a graphics processing unit, a microprocessor, a controller, a microcontroller, a digital signal processor, a field-programmable gate array, an application-specific integrated circuit, and/or another type of processing component. The processor 920 may be implemented in hardware, firmware, or a combination of hardware and software. In some implementations, the processor 920 includes one or more processors capable of being programmed to perform one or more operations or processes described elsewhere herein.

The memory 930 includes volatile and/or nonvolatile memory, such as random access memory (RAM), read only memory (ROM), a hard disk drive, and/or another type of memory (e.g., a flash memory, a magnetic memory, and/or an optical memory). The memory 930 may include internal memory (e.g., RAM, ROM, or a hard disk drive) and/or removable memory (e.g., removable via a universal serial bus connection). In some implementations, the memory 930 is a non-transitory computer-readable medium. The memory 930 stores information, one or more instructions, and/or software (e.g., one or more software applications) related to the operation of the device 900. In some implementations, the memory 930 includes one or more memories that are coupled (e.g., communicatively coupled) to one or more processors (e.g., processor 920), such as via the bus 910. Communicative coupling between a processor 920 and a memory 930 enables the processor 920 to read and/or process information stored in the memory 930 and/or to store information in the memory 930.

The input component 940 enables the device 900 to receive input, such as user input and/or sensed input. For example, the input component 940 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 950 enables the device 900 to provide output, such as via a display, a speaker, and/or a light-emitting diode. The communication component 960 enables the device 900 to communicate with other devices via a wired connection and/or a wireless connection. For example, the communication component 960 may include a receiver, a transmitter, a transceiver, a modem, a network interface card, and/or an antenna.

In some implementations, the device 900 performs one or more operations or processes described herein. For example, a non-transitory computer-readable medium (e.g., memory 930) may store a set of instructions (e.g., one or more instructions or code) for execution by the processor 920. The processor 920 may execute the set of instructions to perform one or more operations or processes described herein. In some implementations, execution of the set of instructions, by one or more processors 920, causes the one or more processors 920 and/or the device 900 to perform one or more operations or processes described herein. In some implementations, hardwired circuitry is used instead of or in combination with the instructions to perform one or more operations or processes described herein. Additionally, or alternatively, the processor 920 may be configured to perform one or more operations or processes described herein. Thus, implementations described herein are not limited to any specific combination of hardware circuitry and software.

The number and arrangement of components shown in FIG. 9 are provided as an example. The device 900 may include additional components, fewer components, different components, or differently arranged components than those shown in FIG. 9. Additionally, or alternatively, a set of components (e.g., one or more components) of the device 900 may perform one or more functions described as being performed by another set of components of the device 900.

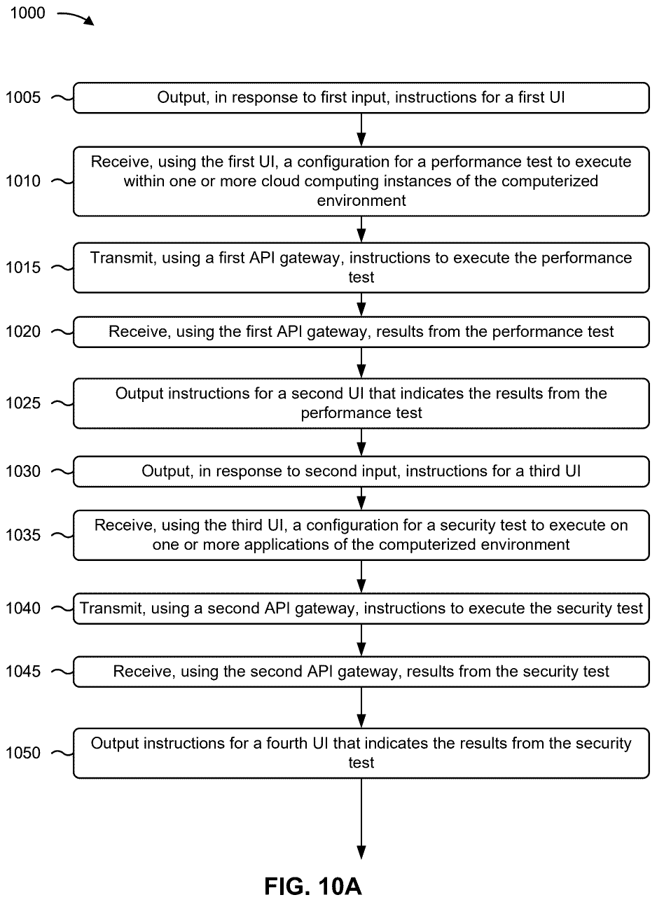

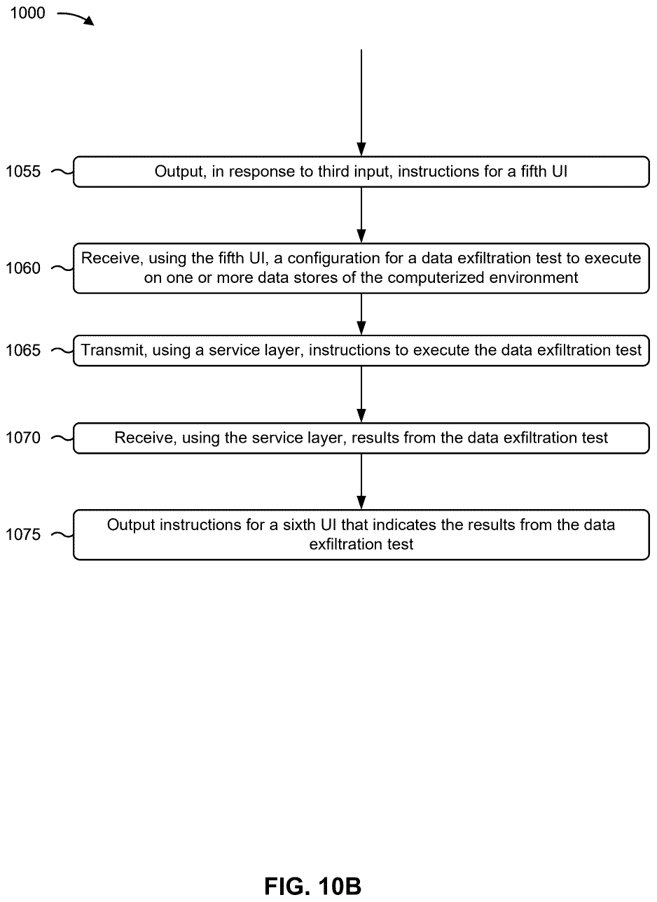

FIGS. 10A-10B are a flowchart of an example process 1000 associated with integrated performance and security testing. In some implementations, one or more process blocks of FIGS. 10A-10B may be performed by an orchestration service 801. In some implementations, one or more process blocks of FIGS. 10A-10B may be performed by another device or a group of devices separate from or including the orchestration service 801, such as a computerized environment 803 and/or a user device 810. Additionally, or alternatively, one or more process blocks of FIGS. 10A-10B may be performed by one or more components of the device 900, such as processor 920, memory 930, input component 940, output component 950, and/or communication component 960.

As shown in FIG. 10A, process 1000 may include outputting, in response to first input, instructions for a first UI (block 1005). For example, the orchestration service 801 (e.g., using processor 920, memory 930, output component 950, and/or communication component 960) may output, in response to first input, instructions for a first UI, as described above in connection with reference number 103 of FIG. 1A. As an example, the first UI may be as described in connection with FIG. 2A.

As further shown in FIG. 10A, process 1000 may include receiving, using the first UI, a configuration for a performance test to execute within one or more cloud computing instances of the computerized environment (block 1010). For example, the orchestration service 801 (e.g., using processor 920, memory 930, input component 940, and/or communication component 960) may receive, using the first UI, a configuration for a performance test to execute within one or more cloud computing instances of the computerized environment, as described above in connection with reference number 105 of FIG. 1A. As an example, the configuration may indicate the cloud computing instance(s) to boot up and which agents to use for monitoring the cloud computing instance(s).

As further shown in FIG. 10A, process 1000 may include transmitting, using a first API gateway, instructions to execute the performance test (block 1015). For example, the orchestration service 801 (e.g., using processor 920, memory 930, and/or communication component 960) may transmit, using a first API gateway, instructions to execute the performance test, as described above in connection with reference number 107 of FIG. 1A. As an example, the instructions may include instructions to boot up and monitor the cloud computing instance(s).

As further shown in FIG. 10A, process 1000 may include receiving, using the first API gateway, results from the performance test (block 1020). For example, the orchestration service 801 (e.g., using processor 920, memory 930, and/or communication component 960) may receive, using the first API gateway, results from the performance test, as described above in connection with reference number 109 of FIG. 1B. As an example, the results may include average CPU usage, peak CPU usage, average memory usage, and/or peak memory usage, among other examples.

As further shown in FIG. 10A, process 1000 may include outputting instructions for a second UI that indicates the results from the performance test (block 1025). For example, the orchestration service 801 (e.g., using processor 920, memory 930, output component 950, and/or communication component 960) may output instructions for a second UI that indicates the results from the performance test, as described above in connection with reference number 111 of FIG. 1B. As an example, the second UI may be as described in connection with FIG. 2B.

As further shown in FIG. 10A, process 1000 may include outputting, in response to second input, instructions for a third UI (block 1030). For example, the orchestration service 801 (e.g., using processor 920, memory 930, output component 950, and/or communication component 960) may output, in response to second input, instructions for a third UI, as described above in connection with reference number 115 of FIG. 1C. As an example, the third UI may be as described in connection with FIG. 3A.

As further shown in FIG. 10A, process 1000 may include receiving, using the third UI, a configuration for a security test to execute on one or more applications of the computerized environment (block 1035). For example, the orchestration service 801 (e.g., using processor 920, memory 930, input component 940, and/or communication component 960) may receive, using the third UI, a configuration for a security test to execute on one or more applications of the computerized environment, as described above in connection with reference number 117 of FIG. 1C. As an example, the configuration may indicate the security test to execute out of a plurality of possible security tests.

As further shown in FIG. 10A, process 1000 may include transmitting, using a second API gateway, instructions to execute the security test (block 1040). For example, the orchestration service 801 (e.g., using processor 920, memory 930, and/or communication component 960) may transmit, using a second API gateway, instructions to execute the security test, as described above in connection with reference number 119 of FIG. 1C. As an example, the instructions may include instructions to execute a script of actions in the computerized environment.

As further shown in FIG. 10A, process 1000 may include receiving, using the second API gateway, results from the security test (block 1045). For example, the orchestration service 801 (e.g., using processor 920, memory 930, and/or communication component 960) may receive, using the second API gateway, results from the security test, as described above in connection with reference number 121 of FIG. 1D. As an example, the results may include a list of actions and whether the actions were detected and/or were blocked.

As further shown in FIG. 10A, process 1000 may include outputting instructions for a fourth UI that indicates the results from the security test (block 1050). For example, the orchestration service 801 (e.g., using processor 920, memory 930, output component 950, and/or communication component 960) may output instructions for a fourth UI that indicates the results from the security test, as described above in connection with reference number 123 of FIG. 1D. As an example, the fourth UI may be as described in connection with FIGS. 3B-3C.

As further shown in FIG. 10B, process 1000 may include outputting, in response to third input, instructions for a fifth UI (block 1055). For example, the orchestration service 801 (e.g., using processor 920, memory 930, output component 950, and/or communication component 960) may output, in response to third input, instructions for a fifth UI, as described above in connection with reference number 131 of FIG. 1E. As an example, the fifth UI may be as described in connection with FIG. 4A.

As further shown in FIG. 10B, process 1000 may include receiving, using the fifth UI, a configuration for a data exfiltration test to execute on one or more data stores of the computerized environment (block 1060). For example, the orchestration service 801 (e.g., using processor 920, memory 930, input component 940, and/or communication component 960) may receive, using the fifth UI, a configuration for a data exfiltration test to execute on one or more data stores of the computerized environment, as described above in connection with reference number 139 of FIG. 1E. As an example, the configuration may indicate a data element to scan for using the data exfiltration test.

As further shown in FIG. 10B, process 1000 may include transmitting, using a service layer, instructions to execute the data exfiltration test (block 1065). For example, the orchestration service 801 (e.g., using processor 920, memory 930, and/or communication component 960) may transmit, using a service layer, instructions to execute the data exfiltration test, as described above in connection with reference number 141 of FIG. 1E. As an example, the instructions may include instructions to search for the data element using a pattern and/or a keyword (e.g., indicated by the configuration).

As further shown in FIG. 10B, process 1000 may include receiving, using the service layer, results from the data exfiltration test (block 1070). For example, the orchestration service 801 (e.g., using processor 920, memory 930, and/or communication component 960) may receive, using the service layer, results from the data exfiltration test, as described above in connection with reference number 143 of FIG. 1F. As an example, the results may include a list of files or a list of endpoints and whether those files or endpoints include the data element.

As further shown in FIG. 10B, process 1000 may include outputting instructions for a sixth UI that indicates the results from the data exfiltration test (block 1075). For example, the orchestration service 801 (e.g., using processor 920, memory 930, output component 950, and/or communication component 960) may output instructions for a sixth UI that indicates the results from the data exfiltration test, as described above in connection with reference number 145 of FIG. 1F. As an example, the sixth UI may be as described in connection with FIG. 4B.

Although FIGS. 10A-10B show example blocks of process 1000, in some implementations, process 1000 may include additional blocks, fewer blocks, different blocks, or differently arranged blocks than those depicted in FIGS. 10A-10B. Additionally, or alternatively, two or more of the blocks of process 1000 may be performed in parallel. The process 1000 is an example of one process that may be performed by one or more devices described herein. These one or more devices may perform one or more other processes based on operations described herein, such as the operations described in connection with FIGS. 1A-1H, FIGS. 2A-2B, FIGS. 3A-3B, FIGS. 4A-4B, FIGS. 5A-5D, FIGS. 6A-6B, and/or FIGS. 7A-7G. Moreover, while the process 1000 has been described in relation to the devices and components of the preceding figures, the process 1000 can be performed using alternative, additional, or fewer devices and/or components. Thus, the process 1000 is not limited to being performed with the example devices, components, hardware, and software explicitly enumerated in the preceding figures.

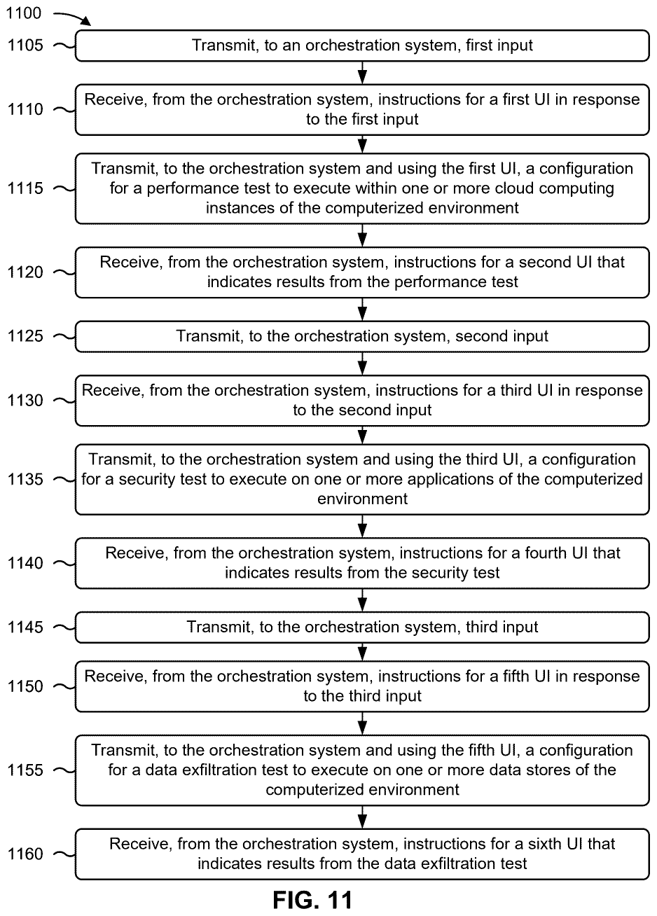

FIG. 11 is a flowchart of an example process 1100 associated with integrated performance and security testing. In some implementations, one or more process blocks of FIG. 11 may be performed by a user device 810. In some implementations, one or more process blocks of FIG. 11 may be performed by another device or a group of devices separate from or including the user device 810, such as an orchestration service 801 and/or a computerized environment 803. Additionally, or alternatively, one or more process blocks of FIG. 11 may be performed by one or more components of the device 900, such as processor 920, memory 930, input component 940, output component 950, and/or communication component 960.

As shown in FIG. 11, process 1100 may include transmitting, to an orchestration system, first input (block 1105). For example, the user device 810 (e.g., using processor 920, memory 930, and/or communication component 960) may transmit, to an orchestration system, first input, as described above in connection with reference number 101 of FIG. 1A. As an example, the first input may indicate interaction with a UI from the orchestration system. The first input may be associated with performance testing.

As further shown in FIG. 11, process 1100 may include receiving, from the orchestration system, instructions for a first UI in response to the first input (block 1110). For example, the user device 810 (e.g., using processor 920, memory 930, and/or communication component 960) may receive, from the orchestration system and at the user device, instructions for a first UI in response to the first input, as described above in connection with reference number 103 of FIG. 1A. As an example, the first UI may be as described in connection with FIG. 2A.

As further shown in FIG. 11, process 1100 may include transmitting, to the orchestration system and using the first UI, a configuration for a performance test to execute within one or more cloud computing instances of the computerized environment (block 1115). For example, the user device 810 (e.g., using processor 920, memory 930, and/or communication component 960) may transmit, to the orchestration system and using the first UI, a configuration for a performance test to execute within one or more cloud computing instances of the computerized environment, as described above in connection with reference number 105 of FIG. 1A. As an example, a user of the user device 810 may interact with elements of the first UI to provide the configuration.

As further shown in FIG. 11, process 1100 may include receiving, from the orchestration system, instructions for a second UI that indicates results from the performance test (block 1120). For example, the user device 810 (e.g., using processor 920, memory 930, and/or communication component 960) may receive, from the orchestration system, instructions for a second UI that indicates results from the performance test, as described above in connection with reference number 111 of FIG. 1B. As an example, the second UI may be as described in connection with FIG. 2B.

As further shown in FIG. 11, process 1100 may include transmitting, to the orchestration system, second input (block 1125). For example, the user device 810 (e.g., using processor 920, memory 930, and/or communication component 960) may transmit, to the orchestration system, second input, as described above in connection with reference number 113 of FIG. 1C. As an example, the second input may indicate interaction with a UI from the orchestration system. The second input may be associated with security testing.

As further shown in FIG. 11, process 1100 may include receiving, from the orchestration system, instructions for a third UI in response to the second input (block 1130). For example, the user device 810 (e.g., using processor 920, memory 930, and/or communication component 960) may receive, from the orchestration system, instructions for a third UI in response to the second input, as described above in connection with reference number 115 of FIG. 1C. As an example, the third UI may be as described in connection with FIG. 3A.

As further shown in FIG. 11, process 1100 may include transmitting, to the orchestration system and using the third UI, a configuration for a security test to execute on one or more applications of the computerized environment (block 1135). For example, the user device 810 (e.g., using processor 920, memory 930, and/or communication component 960) may transmit, to the orchestration system and using the third UI, a configuration for a security test to execute on one or more applications of the computerized environment, as described above in connection with reference number 117 of FIG. 1C. As an example, a user of the user device 810 may interact with elements of the third UI to provide the configuration.

As further shown in FIG. 11, process 1100 may include receiving, from the orchestration system, instructions for a fourth UI that indicates results from the security test (block 1140). For example, the user device 810 (e.g., using processor 920, memory 930, and/or communication component 960) may receive, from the orchestration system, instructions for a fourth UI that indicates results from the security test, as described above in connection with reference number 123 of FIG. 1D. As an example, the fourth UI may be as described in connection with FIGS. 3B-3C.

As further shown in FIG. 11, process 1100 may include transmitting, to the orchestration system, third input (block 1145). For example, the user device 810 (e.g., using processor 920, memory 930, and/or communication component 960) may transmit, to the orchestration system, third input, as described above in connection with reference number 129 of FIG. 1E. As an example, the third input may indicate interaction with a UI from the orchestration system. The third input may be associated with data exfiltration testing.

As further shown in FIG. 11, process 1100 may include receiving, from the orchestration system, instructions for a fifth UI in response to the third input (block 1150). For example, the user device 810 (e.g., using processor 920, memory 930, and/or communication component 960) may receive, from the orchestration system, instructions for a fifth UI in response to the third input, as described above in connection with reference number 131 of FIG. 1E. As an example, the fifth UI may be as described in connection with FIG. 4A.

As further shown in FIG. 11, process 1100 may include transmitting, to the orchestration system and using the fifth UI, a configuration for a data exfiltration test to execute on one or more data stores of the computerized environment (block 1155). For example, the user device 810 (e.g., using processor 920, memory 930, and/or communication component 960) may transmit, to the orchestration system and using the fifth UI, a configuration for a data exfiltration test to execute on one or more data stores of the computerized environment, as described above in connection with reference number 139 of FIG. 1E. As an example, a user of the user device 810 may interact with elements of the fifth UI to provide the configuration.

As further shown in FIG. 11, process 1100 may include receiving, from the orchestration system, instructions for a sixth UI that indicates results from the data exfiltration test (block 1160). For example, the user device 810 (e.g., using processor 920, memory 930, and/or communication component 960) may receive, from the orchestration system, instructions for a sixth UI that indicates results from the data exfiltration test, as described above in connection with reference number 145 of FIG. 1F. As an example, the sixth UI may be as described in connection with FIG. 4B.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel. The process 1100 is an example of one process that may be performed by one or more devices described herein. These one or more devices may perform one or more other processes based on operations described herein, such as the operations described in connection with FIGS. 1A-1H, FIGS. 2A-2B, FIGS. 3A-3B, FIGS. 4A-4B, FIGS. 5A-5D, FIGS. 6A-6B, and/or FIGS. 7A-7G. Moreover, while the process 1100 has been described in relation to the devices and components of the preceding figures, the process 1100 can be performed using alternative, additional, or fewer devices and/or components. Thus, the process 1100 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing unified control for testing within a computerized environment, the system comprising:
one or more memories; and
one or more processors, communicatively coupled to the one or more memories, configured to:
output, in response to first input from a user device, instructions for a first user interface (UI);
receive, from the user device and using the first UI, a configuration for a performance test to execute within one or more cloud computing instances of the computerized environment;
transmit, using a first application programming interface (API) gateway, instructions to execute the performance test;
receive, using the first API gateway, results from the performance test;
output, to the user device, instructions for a second UI that indicates the results from the performance test;
output, in response to second input from the user device, instructions for a third UI;
receive, from the user device and using the third UI, a configuration for a security test to execute on one or more applications of the computerized environment;
transmit, using a second API gateway, instructions to execute the security test;
receive, using the second API gateway, results from the security test;
output, to the user device, instructions for a fourth UI that indicates the results from the security test;
output, in response to third input from the user device, instructions for a fifth UI;
receive, from the user device and using the fifth UI, a configuration for a data exfiltration test to execute on one or more data stores of the computerized environment;
transmit, using a service layer, instructions to execute the data exfiltration test;
receive, using the service layer, results from the data exfiltration test; and
output, to the user device, instructions for a sixth UI that indicates the results from the data exfiltration test.

2. The system of claim 1, wherein the one or more processors are configured to:
output, to the user device, instructions for a seventh UI that indicates the performance test, the security test, and the data exfiltration test along with corresponding statuses.

3. The system of claim 1, wherein the first UI includes a set of UI elements for configuring each cloud computing instance of the one or more cloud computing instances.

4. The system of claim 1, wherein the third UI includes a selector for choosing the security test from a plurality of possible security tests.

5. The system of claim 1, wherein the fifth UI includes a selector for choosing a data element for the data exfiltration test.

6. The system of claim 1, wherein the instructions to execute the performance test comprise instructions to boot up and monitor the one or more cloud computing instances.

7. The system of claim 1, wherein the instructions to execute the security test comprise instructions to execute a script of actions in the computerized environment.

8. A method of using unified control of testing within a computerized environment, comprising:
transmitting, to an orchestration system and from a user device, first input;
receiving, from the orchestration system and at the user device, instructions for a first user interface (UI) in response to the first input;
transmitting, to the orchestration system, from the user device, and using the first UI, a configuration for a performance test to execute within one or more cloud computing instances of the computerized environment;
receiving, from the orchestration system and at the user device, instructions for a second UI that indicates results from the performance test;
transmitting, to the orchestration system and from the user device, second input;
receiving, from the orchestration system and at the user device, instructions for a third UI in response to the second input;
transmitting, to the orchestration system, from the user device, and using the third UI, a configuration for a security test to execute on one or more applications of the computerized environment;
receiving, from the orchestration system and at the user device, instructions for a fourth UI that indicates results from the security test;
transmitting, to the orchestration system and from the user device, third input;
receiving, from the orchestration system and at the user device, instructions for a fifth UI in response to the third input;
transmitting, to the orchestration system, from the user device, and using the fifth UI, a configuration for a data exfiltration test to execute on one or more data stores of the computerized environment; and
receiving, from the orchestration system and at the user device, instructions for a sixth UI that indicates results from the data exfiltration test.

9. The method of claim 8, further comprising:
receiving, from the orchestration system and at the user device, instructions for a seventh UI that indicates the performance test, the security test, and the data exfiltration test along with corresponding statuses;
transmitting, to the orchestration system and from the user device, an indication of an interaction with the seventh UI; and
receiving, from the orchestration system, at the user device, and in response to the indication, instructions for an eighth UI that indicates details of the performance test, the security test, or the data exfiltration test.

10. The method of claim 8, wherein the second UI comprises a table with the results sorted by the one or more cloud computing instances.

11. The method of claim 8, wherein the fourth UI comprises a table with the results sorted by actions included in the security test.

12. The method of claim 11, further comprising:
transmitting, to the orchestration system and from the user device, a request for additional details; and
receiving, from the orchestration system, at the user device, and in response to the request, at least one log file associated with the results of the security test.

13. The method of claim 8, wherein the sixth UI comprises a list of files or a list of endpoints that failed the data exfiltration test.

14. The method of claim 8, further comprising:
transmitting, to the orchestration system and from the user device, a configuration for a workstation performance test to execute on one or more workstations; and
receiving, from the orchestration system and at the user device, results from the workstation performance test.

15. A non-transitory computer-readable medium storing a set of instructions for using unified control of testing within a computerized environment, the set of instructions comprising:
one or more instructions that, when executed by one or more processors of a device, cause the device to:
receive, from an orchestration system, a form page associated with a performance test, a security test, or a data exfiltration test;
perform an application programming interface (API) call to receive a configuration file that encodes a hash map;
receive, using a first user interface (UI) element of the form page, a first portion of a configuration;
modify a second UI element of the form page based on the first portion of the configuration and the hash map;
receive, using the second UI element of the form page, a second portion of the configuration; and
transmit, to the orchestration system, the configuration in response to confirmation from a user.

16. The non-transitory computer-readable medium of claim 15, wherein the first UI element comprises a first drop-down menu, and the second UI element comprises a second drop-down menu.

17. The non-transitory computer-readable medium of claim 15, wherein the one or more instructions, that cause the device to modify the second UI element, cause the device to:
make the second UI element visible in response to receiving the first portion of the configuration.

18. The non-transitory computer-readable medium of claim 15, wherein the one or more instructions, that cause the device to modify the second UI element, cause the device to:
load options for the second UI element based on the hash map and the first portion of the configuration.

19. The non-transitory computer-readable medium of claim 15, wherein the configuration file comprises an extensible markup language file or a JavaScript object notation file.

20. The non-transitory computer-readable medium of claim 15, wherein the API call is to an endpoint that is separate from the orchestration system.
